(19) United States
(12) Patent Application Publication
(10) Pub. No.: US 2017/0010014 A1
(43) Pub. Date: Jan. 12, 2017

(54) AIR CONDITIONER TEST OPERATION APPLICATION, AND AIR CONDITIONER TEST OPERATION SYSTEM

(71) Applicant: JOHNSON CONTROLS-HITACHI AIR CONDITIONING TECHNOLOGY (HONG KONG) LIMITED, Hong Kong (CN)

(72) Inventors: Katsuya MIYATA, Tokyo (JP); Shinya SUENAGA, Tokyo (JP); Naoya SUGIYAMA, Tokyo (JP); Makoto ITOH, Tokyo (JP); Emi SAITO, Tokyo (JP); Tatsuya SUGIYAMA, Tokyo (JP)

(21) Appl. No.: 15/113,255

(22) PCT Filed: Jan. 27, 2014
(86) PCT No.: PCT/JP2014/051603

§ 371 Date: Jul. 21, 2016

(51) Int. Cl. F24F 11/00; G05B 15/02

(52) U.S. Cl. CPC F24F 11/006; F24F 11/0086; G05B 15/02; F24F 2011/0052; F24F 2011/0068; F24F 2011/0091; F24F 2011/0071

(57) ABSTRACT

An air conditioner test operation application which allows to input control inputs for test operation of an air conditioner from a mobile terminal. Through input of a prescribed control input to a control input unit of the mobile terminal, model information pertaining to units that belong to a prescribed group to undergo test operation is not displayed on the display unit of the mobile terminal by the controller of the mobile terminal, whereas model information pertaining to the other group is displayed; and through input of a display switching control input to the control input unit of the mobile terminal, the model information pertaining to the other group that was not being displayed is displayed on the display unit of the mobile terminal by the controller of the mobile terminal, whereas the model information pertaining to the one group that was being displayed ceases to be displayed.

### TECHNICAL FIELD

The present invention relates to an air-conditioner test-operation application and an air-conditioner test-operation system.

### BACKGROUND ART

Conventionally, there have been air-conditioner control systems using a mobile terminal such as a smartphone. For example, Patent Literature 1 describes an air-conditioner control system which enables centralized control of information on pieces of air-conditioning equipment, by transferring to a mobile terminal information on the pieces of air-conditioning equipment collected by a centralized controller and further transferring the transferred information from the mobile terminal to an administrative server.

### CITATION LIST

### Patent Literature

Patent Literature 1: Japanese Patent Laid-open No. 2013-24546

### SUMMARY OF INVENTION

### Technical Problem

However, Patent Literature 1 does not describe a manner of performing a test operation by using a mobile terminal such as a smartphone. In the conventional test operation, a person of a service supplier operates pieces of air-conditioning equipment in succession by using remote controllers in hand, and monitors various types of pressures and temperatures inside the pieces of air-conditioning equipment during operation of the pieces of air-conditioning equipment. It is bothersome to move to the site and manipulate a number of remote controllers. In addition, jigs and a personal computer which are dedicated to the monitoring are used, and there are many items to be monitored. Therefore, the person of the service supplier performing the test operation is required to have a high skill.

In view of above, the object of the present invention is to provide an air-conditioner test-operation application which enables manipulation for test operation of pieces of air-conditioning equipment by use of a mobile terminal and realizes cost reduction, and to provide an air-conditioner test-operation system including a mobile terminal executing the air-conditioner test-operation application.

### Solution to Problem

In order to solve the aforementioned problems, an air-conditioner test-operation system according to the present invention is characterized in that, in an air-conditioner test-operation application executed by a mobile terminal, when a predetermined manipulation is made on a manipulation unit in the mobile terminal, a control unit in the mobile terminal causes a display unit in the mobile terminal to display information on equipment types of ones, belonging to a group other than a predetermined group subject to a test operation, of pieces of outdoor equipment and pieces of indoor equipment constituting an air-conditioning system, and not to display information on equipment types of ones, belonging to the predetermined group, of the pieces of outdoor equipment and the pieces of indoor equipment, and when a manipulation for display switching is made on the manipulation unit in the mobile terminal, the control unit in the mobile terminal causes the display unit in the mobile terminal to display the information on the equipment types of the ones belonging to the predetermined group which is not displayed until then, and not to display the information on the equipment types of the ones belonging to the group other than the predetermined group which is displayed until then.

### Advantageous Effect of Invention

According to the present invention, it is possible to provide an air-conditioner test-operation application which enables manipulation for test operation of pieces of air-conditioning equipment by use of a mobile terminal and realizes cost reduction, and to provide an air-conditioner test-operation system including a mobile terminal executing the air-conditioner test-operation application.

The problems, structures, and advantageous effects other than those described above will be clarified by the following explanations on embodiments.

### BRIEF DESCRIPTION OF THE DRAWINGS

FIG. 1 is a configuration diagram of the entire system according to a first embodiment of the present invention.

FIG. 2 is a system diagram of a refrigeration cycle in pieces of air-conditioning equipment according to the first embodiment of the present invention.

FIG. 3 is a functional block diagram of a piece of outdoor equipment according to the first embodiment of the present invention.

FIG. 4 is a functional block diagram of a piece of indoor equipment and a remote controller according to the first embodiment of the present invention.

FIG. 5 is functional block diagram of a wireless adapter according to the first embodiment of the present invention.

FIG. 6 is functional block diagram of a mobile terminal according to the first embodiment of the present invention.

FIG. 7 is a functional block diagram of an administrative server according to the first embodiment of the present invention.

FIG. 8 is a process flow diagram across respective pieces of equipment according to the first embodiment of the present invention.

FIG. 9 is a process flow diagram across respective pieces of equipment according to the first embodiment of the present invention.

FIG. 10 is a process flow diagram across respective pieces of equipment according to the first embodiment of the present invention.

FIG. 11 is a diagram illustrating examples of screens on a mobile terminal according to the first embodiment of the present invention.

FIG. 12 is a diagram illustrating examples of screens on the mobile terminal according to the first embodiment of the present invention.

FIG. 13 is a diagram illustrating an example of a data structure of connection-confirmation information according to the first embodiment of the present invention.

FIG. 14 is a diagram illustrating an example of a data structure of test-operation schedule information according to the first embodiment of the present invention.

FIG. 15 is a diagram illustrating an example of a data structure of test-operation result information according to the first embodiment of the present invention.

FIG. 16 is a process flow diagram across respective pieces of equipment according to a second embodiment of the present invention.

FIG. 17 is a process flow diagram across respective pieces of equipment according to a third embodiment of the present invention.

### DESCRIPTION OF EMBODIMENT

Hereinbelow, embodiments of the present invention are explained with reference to drawings. The same or equivalent elements bear the same reference numbers through the drawings.

### Embodiment 1

In the present embodiment, an air-conditioner test-operation system is explained. The air-conditioner test-operation system enables a person of a service supplier to easily perform, by use of a mobile terminal such as a smartphone, confirmation of connection-confirmation results of a plurality of pieces of air-conditioning equipment, upload of the connection-confirmation results to an administrative server, initial setting for the plurality of pieces of air-conditioning equipment, generation of a test-operation schedule for the plurality of pieces of air-conditioning equipment, starting of a test operation, confirmation of a result of the test operation, upload of the result of the test operation to the administrative server, and output of the result of the test operation to a printer.

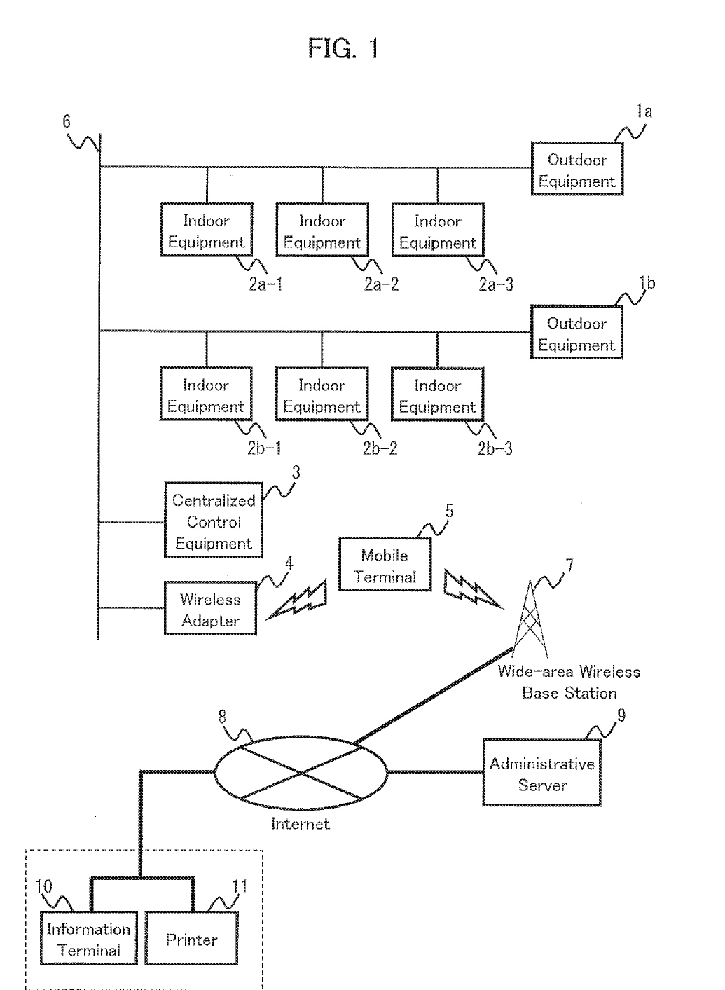

FIG. 1 is an overall view of the air-conditioner test-operation system to which the present invention is applied. The air-conditioner test-operation system illustrated in FIG. 1 is constituted by pieces of outdoor equipment 1 (1a, 1b), pieces of indoor equipment 2 (2a-1 to 2a-3, 2b-1 to 2b-3), centralized control equipment 3, a wireless adapter 4, a mobile terminal 5, an air-conditioner-communication transmission line 6, a wide-area wireless base station 7, the Internet 8, an administrative server 9, an information terminal 10, and a printer 11.

The pieces of outdoor equipment 1 and the pieces of indoor equipment 2 are connected by the refrigerant piping to form a refrigeration cycle as explained later. In FIG. 1, two pieces of outdoor equipment 1 and six pieces of indoor equipment 2 are illustrated. However, the system can be generally constituted by at least one piece of outdoor equipment 1 and at least one piece of indoor equipment 2. A remote controller is connected to each piece of indoor equipment 2 although not illustrated in FIG. 1.

The centralized control equipment 3 is connected to the pieces of outdoor equipment 1 and the pieces of indoor equipment 2 through the air-conditioner-communication transmission line 6, and monitors and controls the connected pieces of equipment. For example, the centralized control equipment 3 can perform, on one or more pieces of the equipment, manipulations for start/halt, operational-mode switching, changing of preset temperature, changing of the wind direction and the air flow, inhibition setting for manipulation of the remote controller, schedule setting, and the like. In addition, the centralized control equipment 3 can provide the status indication and alarm indication of the connected equipment.

The wireless adapter 4 is connected to the piece of outdoor equipment 1 and the piece of indoor equipment 2 through the air-conditioner-communication transmission line 6. In addition, the wireless adapter 4 performs data exchange with the mobile terminal 5 by wireless communication. The manner of the wireless communication is, for example, WiFi (registered trademark), Bluetooth (registered trademark), or Zigbee (registered trademark). Alternatively, a wireless access point (wireless base station) may be arranged between the wireless adapter 4 and the mobile terminal 5. The wireless adapter 4 transmits to the mobile terminal 5 information on the current operation of the pieces of outdoor equipment 1 and the pieces of indoor equipment 2, and controls the pieces of outdoor equipment 1 and the pieces of indoor equipment 2, according to instructions from the mobile terminal 5.

Further, the mobile terminal 5 can be connected to the Internet 8 through the wide-area wireless base station 7. The manner of wireless communication is, for example, 3G (3rd Generation), LTE (registered trademark), or WiMAX (registered trademark).

The administrative server 9 is connected to the Internet 8, and performs data exchange with the mobile terminal 5. The administrative server 9 holds connection information and the like on the pieces of air-conditioning equipment which are transmitted from the mobile terminal 5. In addition, the administrative server 9 holds a database for each type of air-conditioning equipment, and transmits to the mobile terminal 5 in response to instructions from the mobile terminal 5.

The information terminal 10 is connected to the Internet 8, and can communicate with the administrative server 9. When the information terminal 10 is used, it is possible to refer to the connection information or the database for each type of air-conditioning equipment which are held in the administrative server 9, and update the database for each type of air-conditioning equipment held in the administrative server 9.

The printer 11 is connected to the Internet 8, and can communicate with the mobile terminal 5 and the information terminal 10. It is possible to output to the printer 11 the information displayed on the mobile terminal 5, according to instructions from the mobile terminal 5.

The air-conditioner test-operation system may include ventilation equipment.

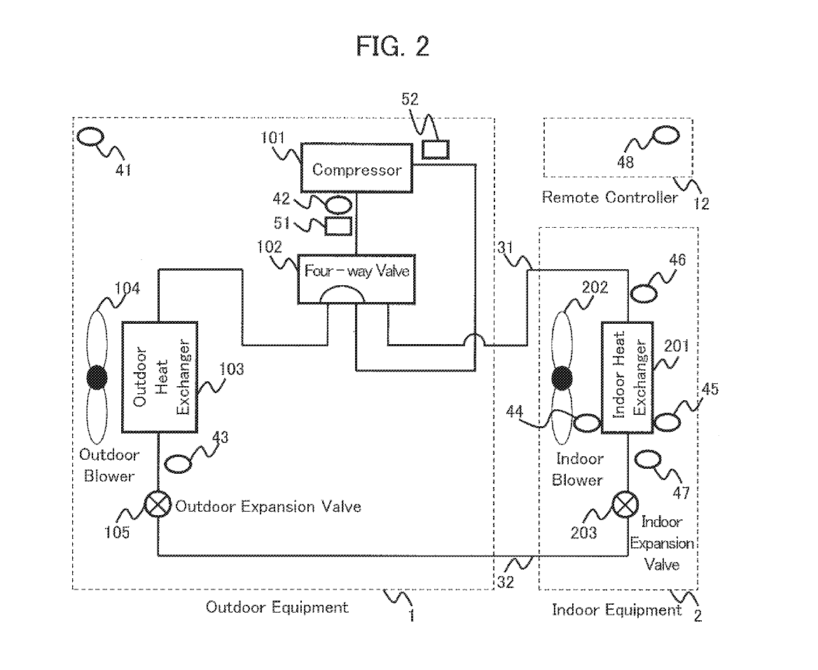

FIG. 2 is a system diagram of a refrigerating cycle in pieces of air-conditioning equipment according to the present invention.

A piece of outdoor equipment 1 and a piece of indoor equipment 2 are connected through gas piping 31 and liquid piping 32. The piece of outdoor equipment 1 includes a compressor 101, a four-way valve 102, an outdoor heat exchanger 103, an outdoor blower 104, and an outdoor expansion valve 105. The compressor 101 is a scroll compressor, a screw compressor, or the like, compresses a refrigerant, and discharges high-pressure gas. The four-way valve 102 switches the destination of the refrigerant gas discharged from the compressor 101 between the outdoor heat exchanger 103 and an indoor heat exchanger 201, so that switching between cooling operation and heating operation is realized. The outdoor blower 104 is arranged to cause outdoor air to pass through the outdoor heat exchanger 103, so that the outdoor heat exchanger 103 exchanges heat between the outdoor air from the outdoor blower and the refrigerant flowing inside. The outdoor expansion valve 105 is realized by an electronic expansion valve or the like, and reduces the pressure of the refrigerant.

In addition, the piece of outdoor equipment 1 includes an outdoor-air temperature sensor 41, a compressor-discharge-gas-piping temperature sensor 42, a heat-exchanger-piping temperature sensor 43, a high-pressure sensor 51, and a low-pressure sensor 52. The outdoor-air temperature sensor 41 measures the temperature of the ambient air of the piece of outdoor equipment 1. The compressor-discharge-gas-piping temperature sensor 42 measures the temperature of the discharge-gas piping of the compressor 101. The heat-exchanger-piping temperature sensor 43 measures the temperature of the liquid piping 32 side of the outdoor heat exchanger 103. The high-pressure sensor 51 measures the pressure of the discharge gas of the compressor 101. The low-pressure sensor 52 measures the pressure of the intake gas of the compressor 101.

The piece of indoor equipment 2 includes the indoor heat exchanger 201, an indoor blower 202, and an indoor expansion valve 203. The indoor blower 202 is arranged to cause room air to pass through the indoor heat exchanger 201, so that the indoor heat exchanger 201 performs heat exchange with the room air. The indoor expansion valve 203 is realized by an electronic expansion valve and reduces the pressure of the refrigerant.

In addition, the piece of indoor equipment 2 includes an intake temperature sensor 44, a blowout temperature sensor 45, a refrigerant-gas-piping temperature sensor 46, a refrigerant-liquid-piping temperature sensor 47. The intake temperature sensor 44 measures the room-air temperature at the inlet of the indoor heat exchanger 201. The blowout temperature sensor 45 measures the room-air temperature at the outlet of the indoor heat exchanger 201. The refrigerant-gas-piping temperature sensor 46 measures the temperature on the gas piping 31 side of the indoor heat exchanger 201. The refrigerant-liquid-piping temperature sensor 47 measures the temperature on the liquid piping 32 side of the indoor heat exchanger 201. Further, a remote controller 12 is connected to the piece of indoor equipment 2. The remote controller 12 includes a remote-controller temperature sensor 48. The remote-controller temperature sensor 48 measures the room-air temperature around the remote controller 12.

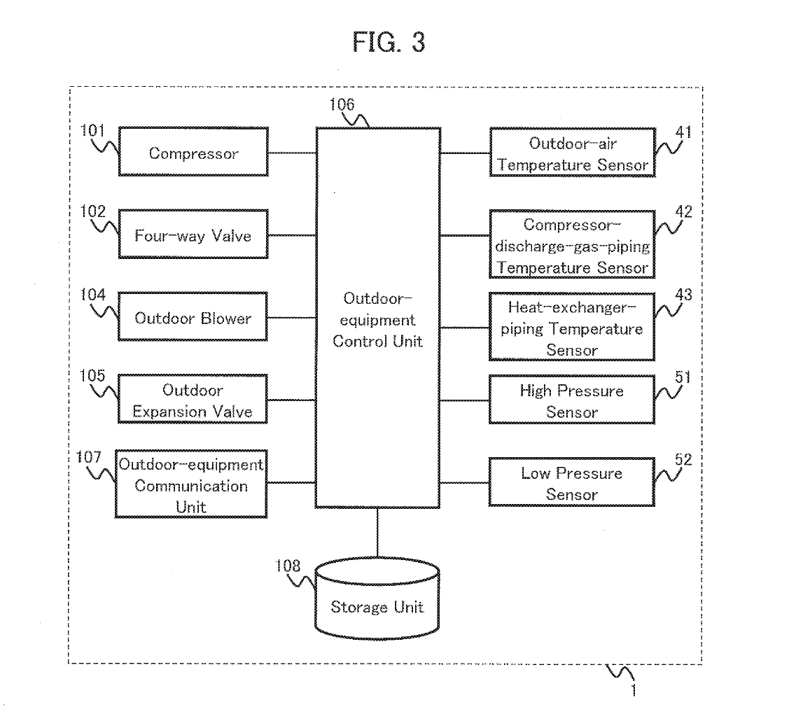

FIG. 3 is a functional block diagram of a piece of outdoor equipment according to the present invention. The outdoor-equipment control unit 106 provided in the piece of outdoor equipment 1 controls the compressor 101, the four-way valve 102, the outdoor blower 104, the outdoor expansion valve 105, an outdoor-equipment communication unit 207, and a storage unit 108. The compressor 101, the four-way valve 102, the outdoor blower 104, and the outdoor expansion valve 105 are already explained. In the control of the compressor 101, the outdoor-equipment control unit 106 designates the operational frequency of the compressor 101. In addition, the compressor 101 has functions of measuring or calculating the primary voltage and the secondary voltage of the internal inverter, and the outdoor-equipment control unit 106 reads out the primary and the secondary voltages. In the control of the four-way valve 102, the outdoor-equipment control unit 106 switches the flow direction of the refrigerant.

In the control of the outdoor blower 104, the outdoor-equipment control unit 106 instructs to operate, and acquires the operational state of the blower. In the control of the outdoor expansion valve 105, the outdoor-equipment control unit 106 changes the aperture of the expansion valve. The outdoor-equipment communication unit 207 communicates with the piece of indoor equipment 2, the centralized control equipment 3, and the wireless adapter 4 through the air-conditioner-communication transmission line 6. The storage unit 108 stores control programs and various preset values for the piece of outdoor equipment 1. In addition, the outdoor-equipment control unit 106 can read out the values measured by the outdoor-air temperature sensor 41, the compressor-discharge-gas-piping temperature sensor 42, the heat-exchanger-piping temperature sensor 43, the high-pressure sensor 51, and the low-pressure sensor 52.

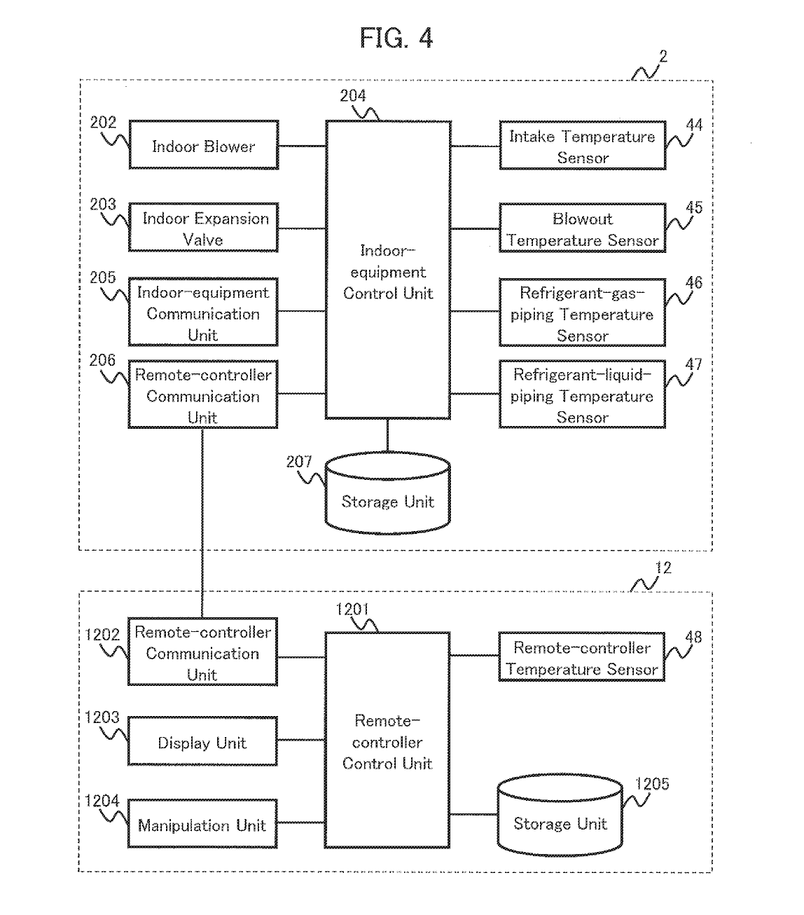

FIG. 4 is a functional block diagram of a piece of indoor equipment and the remote controller according to the present invention. The indoor-equipment control unit 204 provided in the piece of indoor equipment 2 controls the indoor blower 202, the indoor expansion valve 203, an indoor-equipment communication unit 205, a remote-controller communication unit 206, and a storage unit 207. The indoor blower 202 and the indoor expansion valve 203 are already explained. In the control of indoor blower 202, the indoor-equipment control unit 204 instructs to operate, and acquires the operational state of the blower. In the control of the indoor expansion valve 203, the indoor-equipment control unit 204 changes the aperture of the expansion valve. The indoor-equipment communication unit 205 communicates with a piece of outdoor equipment 1, the centralized control equipment 3, and the wireless adapter 4 through the air-conditioner-communication transmission line 6. The remote-controller communication unit 206 communicates with the remote controller 12. The storage unit 207 stores control programs and various preset values for the piece of indoor equipment 2, and various internal states of the piece of indoor equipment 2. The various preset values include a preset temperature, an operational mode, air flow setting, and the like. The various internal states include an alarm code which specifically indicates the type of an abnormality when the abnormality occurs.

In addition, the indoor-equipment control unit 204 can read out the values measured by the intake temperature sensor 44, the blowout temperature sensor 45, the refrigerant-gas-piping temperature sensor 46, and the refrigerant-liquid-piping temperature sensor 47.

A remote-controller control unit 1201 provided in the remote controller 12 controls a remote-controller communication unit 1202, a display unit 1203, a manipulation unit 1204, and a storage unit 1205. The remote-controller communication unit 1202 communicates with the pieces of indoor equipment 2. The display unit 1203 is constituted by an LCD (liquid crystal display), LEDs (light emitting diodes), and the like, and displays information in conjunction with the pieces of indoor equipment or the remote controller. The manipulation unit 1204 is constituted by buttons, switches, a touch panel, and the like, and receives inputs from a user. The storage unit 1205 stores control programs and various preset values for the remote controller 12, and various internal states of the remote controller 12. The various preset values include a preset temperature, an operational mode, air flow setting, and the like. The various internal states include an alarm code which specifically indicates the type of an abnormality when the abnormality occurs. Further, the remote-controller control unit 1201 can read out the value measured by the remote-controller temperature sensor 48.

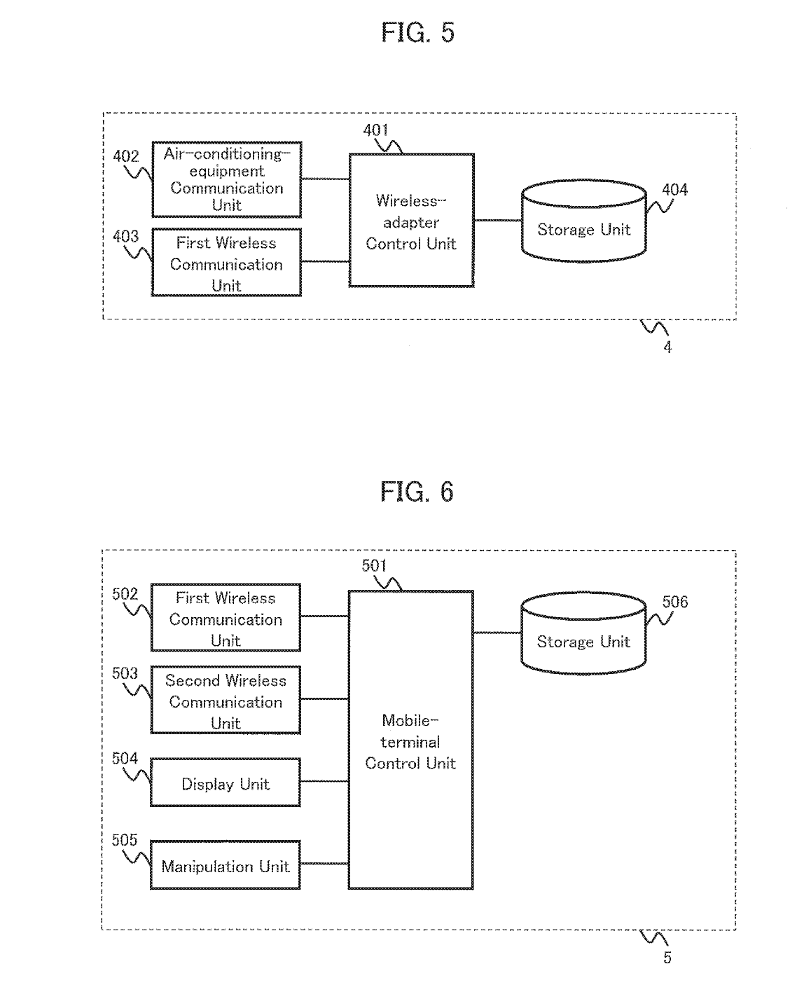

FIG. 5 is functional block diagram of the wireless adapter according to the present invention.

The wireless-adapter control unit 401 provided in the wireless adapter 4 controls an air-conditioning-equipment communication unit 402, a first wireless communication unit 403, and a storage unit 404. The air-conditioning-equipment communication unit 402 communicates with the pieces of outdoor equipment 1, the pieces of indoor equipment 2, and the centralized control equipment 3 through the air-conditioner-communication transmission line 6. The first wireless communication unit 403 performs wireless communication with the mobile terminal 5. The manner of the wireless communication is, for example, WiFi (registered trademark), Bluetooth (registered trademark), or Zigbee (registered trademark). The storage unit 404 stores control programs and various preset values for the wireless adapter 4, and information on the current status acquired from the pieces of outdoor equipment 1 and the pieces of indoor equipment 2. The wireless adapter 4 may be provided separately from the pieces of air-conditioning equipment, or may be attached to the pieces of air-conditioning equipment (the pieces of outdoor equipment 1, the pieces of indoor equipment 2, the centralized control equipment 3, and the like). In addition, when the pieces of air-conditioning equipment can have the function of the wireless adapter 4, the wireless adapter 4 may be implemented as a function of the pieces of air-conditioning equipment.

FIG. 6 is functional block diagram of the mobile terminal according to the present invention.

A mobile-terminal control unit 501 provided in the mobile terminal 5 controls a first wireless communication unit 502, a second wireless communication unit 503, a display unit 504, a manipulation unit 505, and a storage unit 506. The first wireless communication unit 502 performs wireless communication with the wireless adapter 4. The manner of the wireless communication system is, for example, WiFi (registered trademark), Bluetooth (registered trademark), or Zigbee (registered trademark). The second wireless communication unit 503 is connected to the Internet 8 through the wide-area wireless base station 7. The manner of the wireless communication system is, for example, 3G (3rd Generation), LTE (registered trademark), or WiMAX (registered trademark).

The display unit 504 is constituted by an LCD, LEDs, and the like, and displays a variety of information. The manipulation unit 505 is constituted by buttons, switches, a touch panel, and the like, and receives inputs from a user. The storage unit 506 stores control programs and various preset values for the mobile terminal 5, and information on the current status of the pieces of outdoor equipment 1 and the pieces of indoor equipment 2 acquired from the wireless adapter 4, and data acquired from the administrative server 9. The control programs for the mobile terminal 5 include an air-conditioner test-operation application for controlling pieces of air-conditioning equipment by performing communication with the wireless adapter 4. The air-conditioner test-operation application may be preinstalled in the mobile terminal 5 or arranged to be downloaded from the administrative server 9. In addition, the display unit 504, the manipulation unit 505, and the storage unit 506 may be arranged as separate devices.

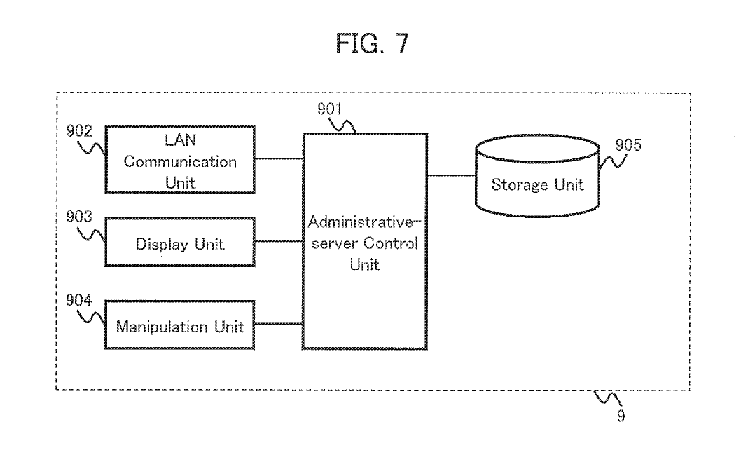

FIG. 7 is a functional block diagram of the administrative server according to the present invention.

An administrative-server control unit 901 provided in the administrative server 9 controls a LAN communication unit 902, a display unit 903, a manipulation unit 904, and a storage unit 905. The LAN communication unit 902 is connected to the Internet 8. The display unit 903 is constituted by an LCD, LEDs, and the like, and displays a variety of information. The manipulation unit 904 is constituted by buttons, switches, a touch panel, a keyboard, a mouse, and the like, and receives inputs from a user. The storage unit 905 stores control programs and various preset values for the administrative server 9 and data acquired from the mobile terminal 5. Further, the storage unit 905 stores the databases of air-conditioning products. The databases include information on the specifications and manuals of the respective pieces of air-conditioning equipment. Further, the display unit 903, the manipulation unit 904, and the storage unit 905 may be arranged as separate devices.

The wireless adapter 4 may be implemented as a function of the pieces of air-conditioning equipment when the pieces of air-conditioning equipment can have the function of the wireless adapter 4 in the arrangement explained below.

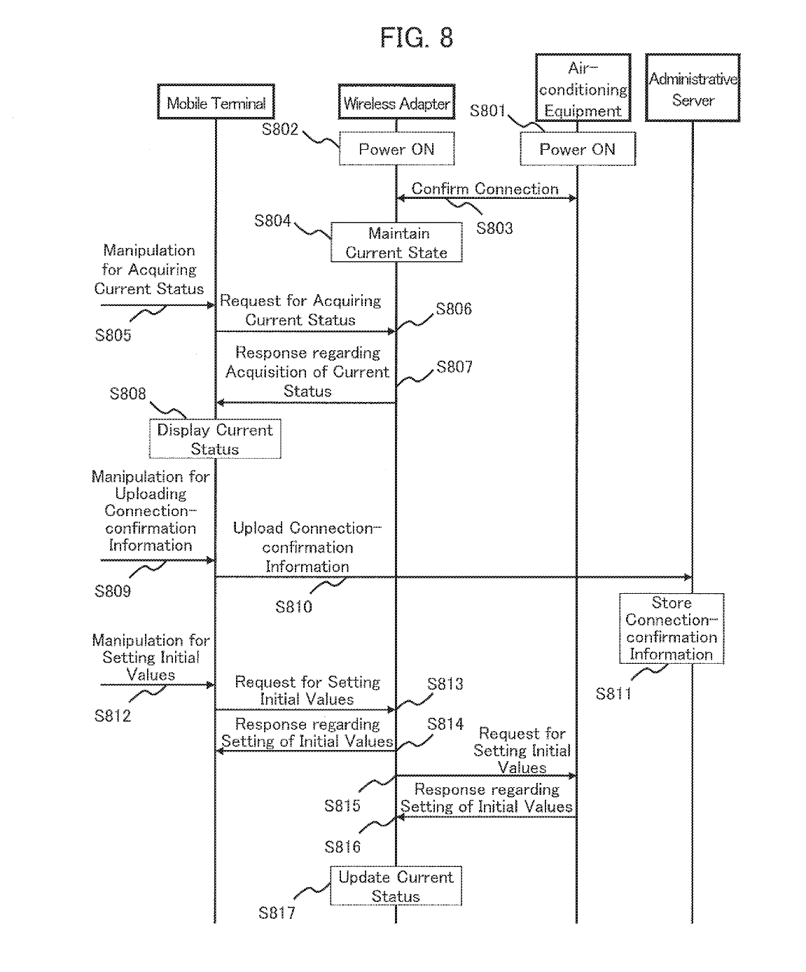

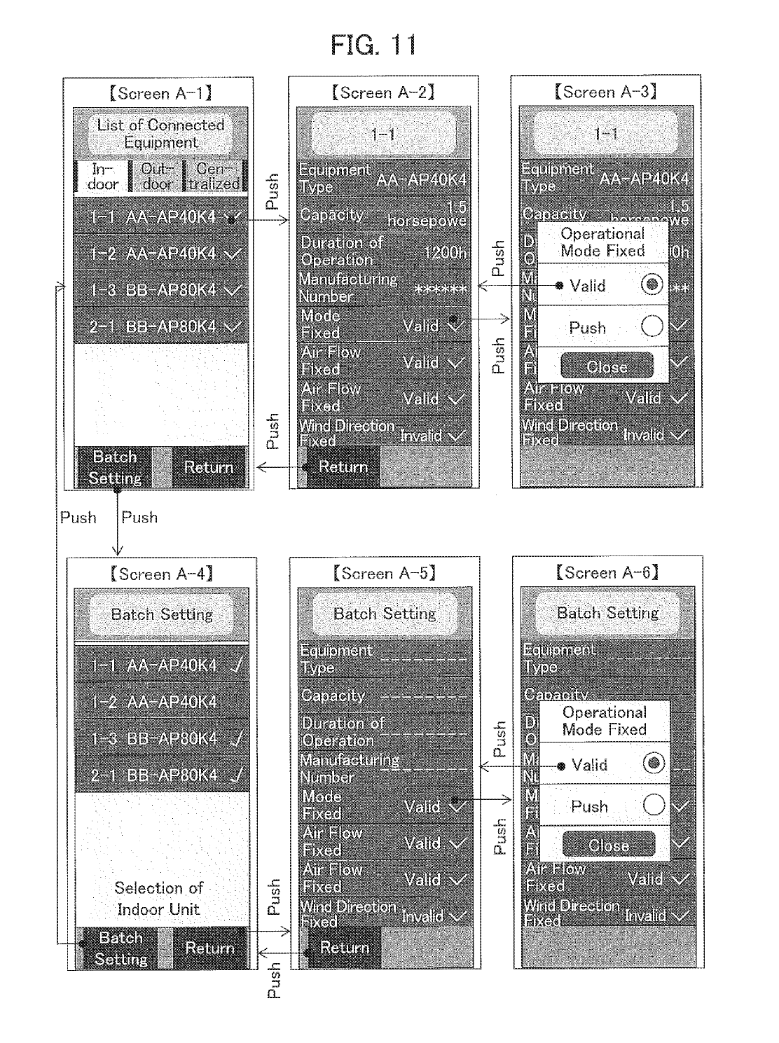

FIG. 8 is a process flow diagram related to a manipulation for acquiring the current status, a manipulation for uploading connection-confirmation information, and a manipulation for setting initial values, among the manipulations for test operation by use of the mobile terminal. In addition, FIG. 11 illustrates examples of screens on the mobile terminal in the process.

When the wireless adapter 4 is powered on (S802) in the state in which the pieces of air-conditioning equipment (the pieces of outdoor equipment 1 and the pieces of indoor equipment 2) are powered (S801), the wireless-adapter control unit 401 in the wireless adapter 4 starts a connection-confirmation process for the pieces of air-conditioning equipment (the pieces of outdoor equipment 1 and the pieces of indoor equipment 2) (S803). The connection-confirmation process is a process for discovering one or more pieces of air-conditioning equipment with which the wireless adapter 4 can communicate through the air-conditioner-communication transmission line 6. The wireless-adapter control unit 401 in the wireless adapter 4 successively transmits predetermined message signals through the air-conditioner-communication transmission line 6 to all refrigerant circuits and addresses. Alternatively, the wireless-adapter control unit 401 may perform broadcast transmission to all refrigerant circuits and addresses.

For example, when a message signal as above is received by the indoor-equipment communication unit 205 in a piece of indoor equipment 2, the indoor-equipment control unit 204 transmits a response signal to the wireless adapter 4 through the indoor-equipment communication unit 205. The response signal transmitted by a piece of air-conditioning equipment contains information indicating the attribute and the status of the piece of air-conditioning equipment (a piece of outdoor equipment 1 or a piece of indoor equipment 2). When a message signal as mentioned before is received by the outdoor-equipment communication unit 107 in a piece of outdoor equipment 1, an outdoor-equipment control unit 106 transmits a response signal to the wireless adapter 4 through the outdoor-equipment communication unit 107. In the following explanations, the piece of air-conditioning equipment which is referred to is assumed to be a piece of outdoor equipment or a piece of indoor equipment.

The information contained in the above response signal may include the model of the piece of air-conditioning equipment connected to the air-conditioning system, the capability (cooling capacity/heating capacity), the equipment type, the manufacturing number, the refrigerant circuit, the address, the operational status (operation/halt), the operational mode (cooling/heating), the preset temperature, the wind direction, the air flow, the remote-controller inhibition status, the total operation time, the setting for fixing the operational mode, the setting for fixing wind direction, the setting for fixing air flow, alarm information, and the like.

In order to collect the above information, the response signal may be constituted by a plurality of predetermined message signals.

When the air-conditioning-equipment communication unit 402 in the wireless adapter 4 receives a normal response signal from a piece of outdoor equipment 1 or a piece of indoor equipment 2, the wireless-adapter control unit 401 recognizes that the piece of outdoor equipment 1 or the piece of indoor equipment 2 is normally connected.

When the connection-confirmation process is completed, the wireless-adapter control unit 401 in the wireless adapter 4 causes the storage unit 404 to store the above information (the information on the current status) contained in the response signal from one or more pieces of air-conditioning equipment and acquired during the connection-confirmation process (S804).

Thereafter, when the condition of the piece of air-conditioning equipment changes, the control unit (the outdoor-equipment control unit 106 or the indoor-equipment control unit 204) in the piece of air-conditioning equipment transmits a message signal to the wireless adapter 4 through the communication unit (the outdoor-equipment communication unit 107 or the indoor-equipment communication unit 205). Then, the wireless adapter 4 receives the message signal at the air-conditioning-equipment communication unit 402, and the wireless-adapter control unit 401 in the wireless adapter 4 recognizes the message signal, and updates the above information on the current status stored in the storage unit 404.

At this time, for example, when the user of the mobile terminal 5 who performs test operation of the piece of air-conditioning equipment makes a manipulation on the manipulation unit 505, the signal from the manipulation unit 505 is received by the mobile-terminal control unit 501, and the mobile-terminal control unit 501 starts the air-conditioner test-operation application stored in the storage unit 506. In addition, when the user of the mobile terminal 5 makes on the manipulation unit 505 a manipulation for acquiring the current status of the piece of air-conditioning equipment (S805), the signal from the manipulation unit 505 is received by the mobile-terminal control unit 501, and the mobile-terminal control unit 501 transmits a request for acquiring the current status to the wireless adapter 4 through the first wireless communication unit 502 (S806). The request for acquiring the current status may require information on a single piece of air-conditioning equipment, or collectively require information on more than one piece of air-conditioning equipment.

When the first wireless communication unit 403 in the wireless adapter 4 receives the request for acquiring the current status, the wireless-adapter control unit 401 transmits a response regarding the acquisition of the current status to the mobile terminal 5 through the first wireless communication unit 403 (S807). This response regarding the acquisition of the current status contains information on the current status of the one or more pieces of air-conditioning equipment which is stored in the storage unit 404 in step S804.

The mobile-terminal control unit 501 in the mobile terminal 5, which receives the signal of the response regarding the acquisition of the current status, controls the display unit 504 to display the current status of the one or more pieces of air-conditioning equipment contained in the received response regarding the acquisition (S808). Examples of screens displayed on the display unit 504 at this time are illustrated as the screens A-1 and A-2 in FIG. 11. In the screen A-1, information on the refrigerant circuits, addresses, and equipment types is indicated in the form of a list. The system is configured such that the indication can be switched by tab selection among the pieces of indoor equipment, the pieces of outdoor equipment, and the centralized control equipment. When a manipulation for selecting a piece of equipment is made on the screen A-1, a transition to the screen A-2 occurs. Then, detailed information on the selected equipment is displayed on the screen A-2.

In other words, when the manipulation unit 505 in the mobile terminal 5 is manipulated, the air-conditioner test-operation application executed by the mobile terminal 5 according to the present embodiment causes the display unit 504 on the mobile terminal 5 not to display information on the equipment types of ones, belonging to a predetermined group (e.g., the group of the pieces of outdoor equipment 1), of the pieces of outdoor equipment 1 and the pieces of indoor equipment 2 constituting the air-conditioning system, and to display information on the equipment types of ones, belonging to another group (e.g., the group of the pieces of indoor equipment 2), of the pieces of outdoor equipment 1 and the pieces of indoor equipment 2. Further, when a manipulation for display switching is made on the manipulation unit 505 in the mobile terminal 5, the air-conditioner test-operation application executed by the mobile terminal 5 according to the present embodiment causes the display unit 504 on the mobile terminal 5 to display information on the equipment types of the ones belonging to the predetermined group (e.g., the group of the outdoor equipment 1) which has not been displayed until then, and not to display information on the equipment types of the ones belonging to the another group (e.g., the group of the indoor equipment 2) which has been displayed until then.

Although only the information on the equipment types has been refer to as an example, it is desirable to display the refrigerant circuit and the address as well as the equipment type as illustrated in the screen A-1. Alternatively, the pieces of equipment may not be grouped into the outdoor equipment 1 and the indoor equipment 2. Instead, it is possible to configure the system such that the pieces of equipment are displayed for each refrigerant circuit, and the display for each refrigerant circuit can be switched by making a manipulation for display switching on the manipulation unit 505 in the mobile terminal 5.

In the case where the mobile terminal 5 is a smartphone, the information which can be displayed is limited since the screen size (of the display unit 504) is limited. The configuration of the air-conditioner test-operation application enables the user of the mobile terminal 5 to easily confirm the configuration of the pieces of outdoor equipment 1 and the pieces of indoor equipment 2 connected to the air-conditioning system. Since the ownership rate of the smartphone has been remarkably increasing in recent years, the above air-conditioner test-operation application enables achievement of the above effect and cost reduction.

When the user of the mobile terminal 5 makes on the manipulation unit 505 a manipulation for uploading connection-confirmation information on the one or more pieces of air-conditioning equipment (S809), the mobile-terminal control unit 501, which receives a signal of this manipulation, transmits a signal for uploading connection-confirmation information to the administrative server 9 through the second wireless communication unit 503 (S810). The administrative server 9 receives this signal through the LAN communication unit 902, and the administrative-server control unit 901 stores the received connection-confirmation information in the storage unit 905 (S811). In this way, the connection-confirmation information on the one or more pieces of air-conditioning equipment (the piece of outdoor equipment 1, the piece of indoor equipment 2, the centralized control equipment, and the like) connected to the air-conditioning system can be easily stored in the administrative server 9 by using the mobile terminal 5. Since the connection-confirmation information is stored in the administrative server 9, this information can be used by the other pieces of equipment. That is, convenience is improved.

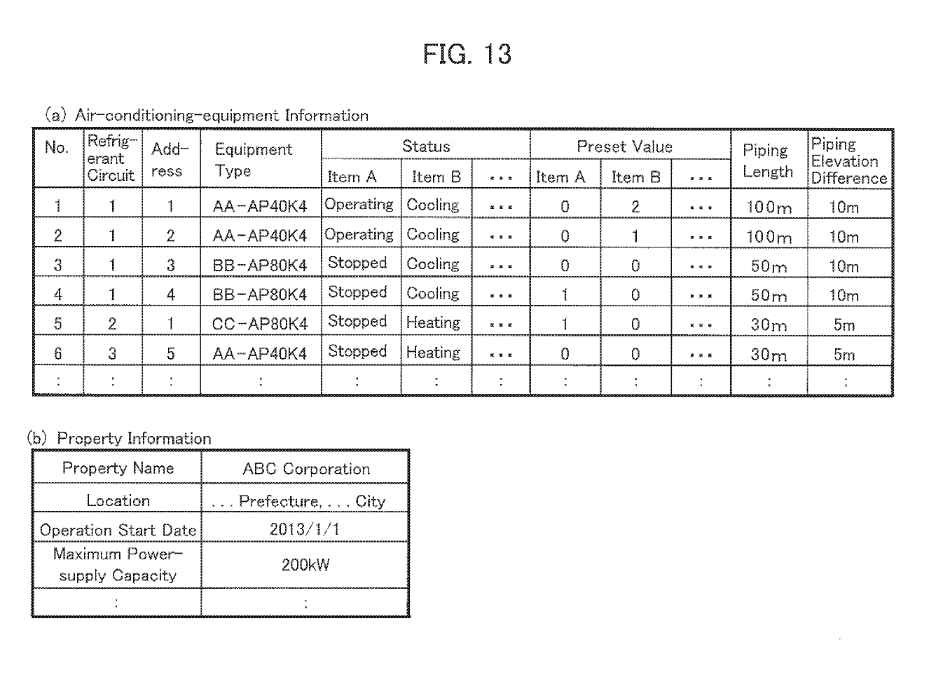

FIG. 13 illustrates an example of a data structure of connection-confirmation information stored in the administrative server 9. The connection-confirmation information includes air-conditioning-equipment information and property information. The air-conditioning-equipment information includes, for example, the sequence number (which is denoted as “No.” in FIG. 13), the refrigerant circuit, the address, the equipment type, various conditions, various preset values, the piping length, and the piping elevation difference (the elevation difference between the inlet and the outlet of the piping), which are assigned to each piece of air-conditioning equipment. The refrigerant circuit, the address, the equipment type, the various conditions, and the various preset values are information items contained in the response regarding the acquisition of the current status in step S807.

The piping length and the piping elevation difference are information items which are caused by the mobile-terminal control unit 501 to store in the storage unit 506 when the user of the mobile terminal 5 manipulates the manipulation unit 505 as needed and the mobile-terminal control unit 501 receives a signal of this manipulation. The property information includes, for example, the name of the property, the location, the operation start date, and the maximum power-supply capacity, each of which is an information item which is caused by the mobile-terminal control unit 501 to store in the storage unit 506 when the user of the mobile terminal 5 manipulates the manipulation unit 505, as the piping length and the piping elevation difference. In addition, the maximum power-supply capacity is an information item which is registered by the user according to the contracted electric power and the like, and is the maximum electric power which is available per day, per month, or per year. The above information items are exemplary items of the air-conditioning-equipment information and the property information, and the air-conditioning-equipment information and the property information may further include other items.

Subsequently, when a user of the mobile terminal 5 makes on the manipulation unit 505 a manipulation for setting initial values in one or more pieces of air-conditioning equipment by using the air-conditioner test-operation application (S812), the mobile-terminal control unit 501, which receives a signal of this manipulation, transmits a signal of a request for setting initial values, to the wireless adapter 4 through the first wireless communication unit 502 (S813). The initial values in the request for setting initial values correspond to an operational condition of the one or more pieces of air-conditioning equipment at the start of operation, and are, for example, the operational mode (heating operation or cooling operation), the air flow of the indoor fan, the air flow of the outdoor fan, the wind direction of the louver, and the like. The request for setting initial values may request setting in a single piece of air-conditioning equipment or collectively request setting in more than one piece of air-conditioning equipment.

When the first wireless communication unit 403 in the wireless adapter 4 receives the above signal of the request for setting initial values, the wireless-adapter control unit 401 transmits a response signal regarding the setting of the initial values to the mobile terminal 5 through the first wireless communication unit 403 (S814), and transmits a request signal for setting initial values to the one or more pieces of air-conditioning equipment through the air-conditioning-equipment communication unit 402 (S815).

When the control unit (the outdoor-equipment control unit 106 or the indoor-equipment control unit 204) in each piece of air-conditioning equipment receives the request for setting initial values at the communication unit (the outdoor-equipment communication unit 107 or the indoor-equipment communication unit 205), the control unit performs the operation control on the basis of the predetermined operational condition which is set by the request for setting initial values.

Therefore, according to the air-conditioner test-operation application in the present embodiment, when the user of the mobile terminal 5 makes on the manipulation unit 505 a manipulation for setting operational conditions of multiple pieces of air-conditioning equipment at the start of operation, and thereafter makes a manipulation for starting operation of the multiple pieces of air-conditioning equipment on the basis of the operational conditions which are set at once, the control units (the outdoor-equipment control unit 106 or the indoor-equipment control unit 204) in the pieces of air-conditioning equipment, which receive the signal of the above manipulation (for requesting the setting of initial values), performs operation control on the basis of the operational conditions which are respectively set in the pieces of air-conditioning equipment.

In addition, the control unit transmits a response signal regarding the setting of the initial values to the wireless adapter 4 through the communication unit (the outdoor-equipment communication unit 107 or the indoor-equipment communication unit 205) in each piece of air-conditioning equipment (S816). When the air-conditioning-equipment communication unit 402 in the wireless adapter 4 receives the response signal regarding the setting of the initial values, the wireless-adapter control unit 401 updates the information on the current status in the storage unit 404 on the basis of the contents of the response signal regarding the setting of the initial values (S817).

The screens A-1 to A-6 in FIG. 11 are examples of screens on the display unit 504 when the user of the mobile terminal 5 makes on the manipulation unit 505 the manipulation for setting the initial values in step S812. When a manipulation for selecting on the screen A-2 an item for which an initial value is to be set is made on the manipulation unit 505, the mobile-terminal control unit 501 controls the display unit 504 such that a transition to the screen A-3 occurs. Similarly, when a manipulation for selecting a preset value is made on the screen A-3, the screen transitions to the screen A-2, and the operation in step S813 is performed. In addition, when a manipulation for setting initial values on multiple pieces of air-conditioning equipment at once is made on the screen A-1, a transition to the screen A-4 occurs. When a manipulation for selecting a piece of equipment on which initial values are to be set is made on the screen A-4, a transition to the screen A-5 occurs. When a manipulation for selecting an item for which an initial value is to be set is made on the screen A-5, a transition to the screen A-6 occurs. When a manipulation for selecting a value to be set is made on the screen A-6, a transition back to the screen A-5 occurs, and the operation in step S813 is performed.

In addition, in order to confirm whether or not the initial values are correctly set, the manipulation for acquiring the current status in step S805 and the manipulation for uploading the connection-confirmation information in step S805 may be performed again after the manipulation for setting initial values in step S812. In this case, the operations are performed in similar manners to the manners explained before.

As explained above, initial values in all the pieces of air-conditioning equipment can be easily set by using the mobile terminal 5.

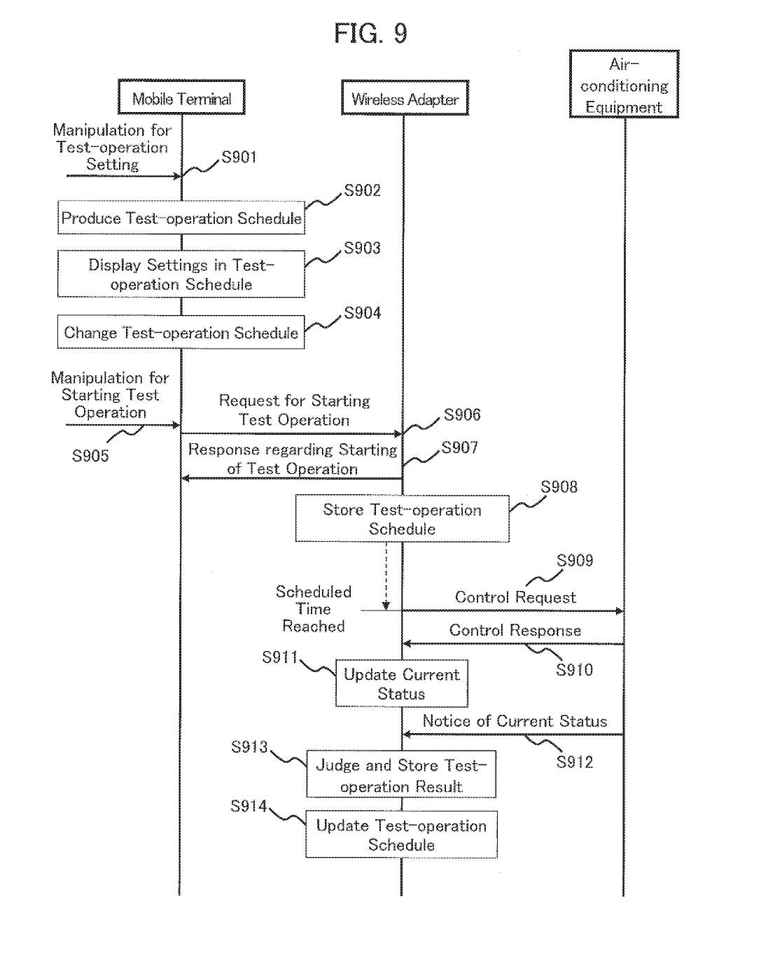

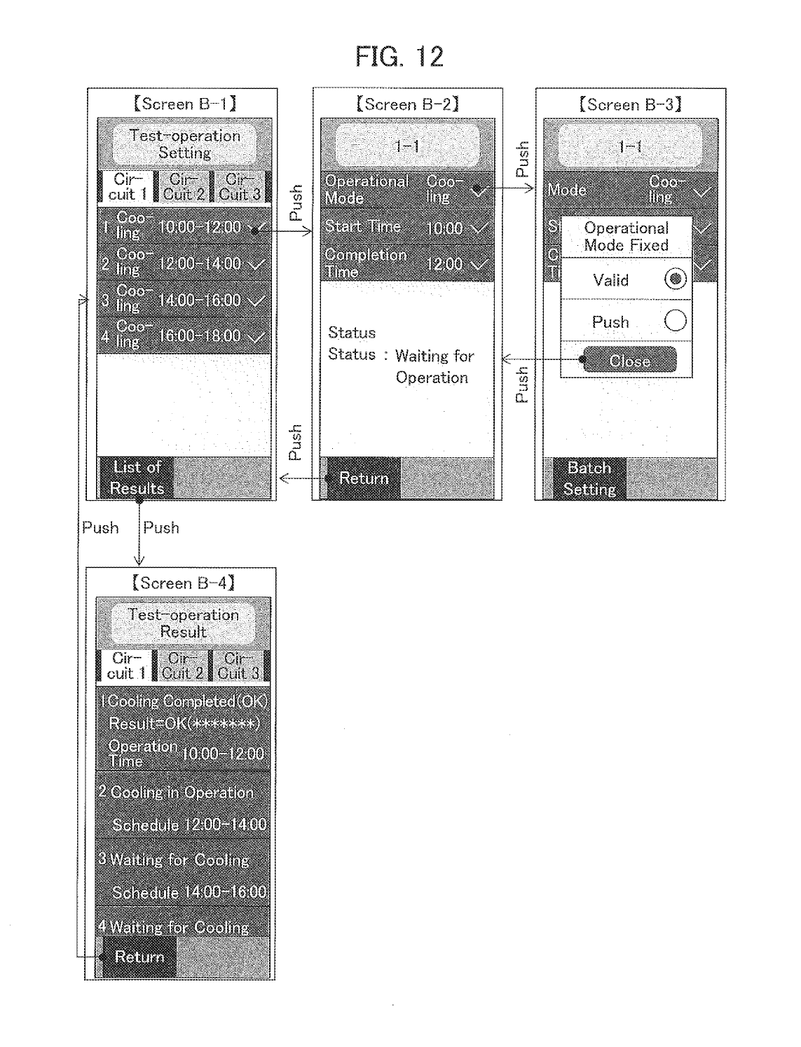

FIG. 9 is a process flow diagram related to a manipulation for setting a schedule among the manipulations for test operation by using the mobile terminal. FIG. 12 illustrates examples of screens on the mobile terminal in this process. When the user of the mobile terminal 5 makes on the manipulation unit 505 a manipulation for test-operation setting of one or more pieces of air-conditioning equipment, by using the air-conditioner test-operation application stored in the storage unit 506 in the mobile terminal 5 (S901), the mobile-terminal control unit 501, which receives a signal of this manipulation, generates a test-operation schedule (S902).

At this time, the mobile-terminal control unit 501 uses the information stored in the storage unit 506 and the information stored in the storage unit 905 in the administrative server 9. Although there is a possibility that the processes in steps S809 to S811 store identical information in the storage unit 506 and the storage unit 905, the information from whichever of the storage unit 506 and the storage unit 905 may be used. In addition, as for detailed information on the specification and information on the manual of each piece of air-conditioning equipment which cannot be acquired in the connection-confirmation process, the information in the storage unit 905 is referred to by communication with the LAN communication unit 902 in the administrative server 9 through the second wireless communication unit 503. Alternatively, part of the above information may be stored in the storage unit 506 in advance by using communication between the second wireless communication unit 503 and the LAN communication unit 902, and referred to later.

Further, although the mobile-terminal control unit 501 is assumed to generate the test-operation schedule in the above explanations, the administrative-server control unit 901 in the administrative server 9 may produce the test-operation schedule and transfer the test-operation schedule to the mobile terminal 5 through the LAN communication unit 902. In this case, even when the mobile terminal 5 is an inexpensive type having low processing capacity, the test-operation schedule can be produced in a short time.

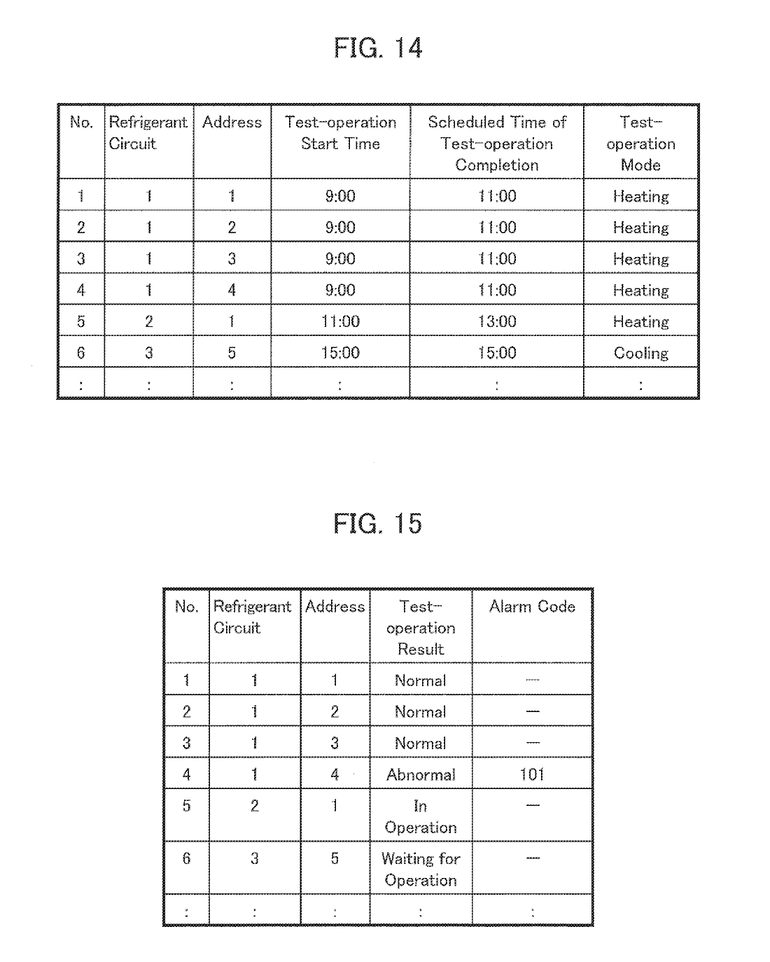

FIG. 14 indicates an example of a data structure of the produced test-operation schedule information. The time at which the test operation is started, the time at which the test operation is completed, and the operational mode are associated with each piece of air-conditioning equipment which is indicated by the refrigerant circuit and the address. in the case where the test-operation schedule is produced by the user of the mobile terminal 5 manipulating the manipulation unit 505, the mobile-terminal control unit 501, which receives a signal of this manipulation, produces the test-operation schedule and stores the test-operation schedule in the storage unit 506.

In other words, according to the air-conditioner test-operation application executed by the mobile terminal 5 in the present embodiment, information on the refrigerant circuit(s) and address(es) of piece(s) of air-conditioning equipment which can be subject to the test operation is acquired by accessing the administrative server 9, or by reading out the information on the refrigerant circuit(s) and address(es) stored in the storage unit 506, and the acquired information is displayed on the display unit 504 of the mobile terminal 5. Then, when the user makes on the manipulation unit 505 a manipulation for setting the test-operation start time for each piece of air-conditioning equipment, a signal of this manipulation is received by the mobile-terminal control unit 501, and the mobile-terminal control unit 501 displays on the display unit 504 the test-operation start time for each piece of air-conditioning equipment which is set by the above manipulation for setting the test-operation start time, as illustrated in FIG. 12.

In addition, when the user makes on the manipulation unit 505 a manipulation for setting a test-operation end time for each piece of air-conditioning equipment, a signal of this manipulation is received by the mobile-terminal control unit 501, and the mobile-terminal control unit 501 displays on the display unit 504 the test-operation end time for each piece of air-conditioning equipment which is set by the above manipulation for setting the test-operation end time, as illustrated in FIG. 12.

Furthermore, according to the air-conditioner test-operation application executed by the mobile terminal 5 in the present embodiment, when the user makes on the manipulation unit 505 a manipulation for setting a test-operation mode for each piece of air-conditioning equipment, a signal of this manipulation is received by the mobile-terminal control unit 501, and the mobile-terminal control unit 501 displays on the display unit 504 the test-operation mode (heating operation or cooling operation) of the test operation for each piece of air-conditioning equipment which is set by the above manipulation for setting the test-operation mode of the test operation, as illustrated in FIG. 12.

Alternatively, the durations of test operations of pieces of air-conditioning equipment may be predetermined to have a common length (e.g., two hours). In this case, the user is not required to make a manipulation for setting the test-operation end time, and the time after the predetermined time elapses from the test-operation start time displayed on the display unit 504 may be displayed as the test-operation end time. Further alternatively, when the mobile-terminal control unit 501 displays on the display unit 504 the test-operation start time for a piece of air-conditioning equipment belonging to a refrigerant circuit, the mobile-terminal control unit 501 may also display on the display unit 504 the same test-operation start time for the other pieces of air-conditioning equipment belonging to the same refrigerant circuit.

In many cases, the test operations of pieces of air-conditioning equipment belonging to the same refrigerant circuit start at the same time. Because of the above configuration, the user is not required to make a manipulation for setting, and convenience can be improved.

In the case where the test-operation schedule is produced by the administrative server 9, the administrative-server control unit 901 sets a predetermined time as the test-operation start time, predetermines the durations of the test operations of the respective pieces of air-conditioning equipment to be a common duration as explained above, sets the test-operation end time on the basis of the predetermined common time, and transmits the test-operation end time to the mobile terminal 5 through the LAN communication unit 902. The mobile terminal 5 receives the transmitted signal through the second wireless communication unit 503, and the mobile-terminal control unit 501 displays the test-operation end time on the display unit 504. Thus, it is possible to achieve an effect similar to the configuration explained before.

In addition, when the mobile-terminal control unit 501 displays on the display unit 504 a start time of test operations for pieces of air-conditioning equipment belonging to a first refrigerant circuit, the mobile-terminal control unit 501 may display on the display unit 504 a start time of test operations for pieces of air-conditioning equipment belonging to a second refrigerant circuit such that the test-operation start time for pieces of air-conditioning equipment belonging to the second refrigerant circuit is shifted by a certain time from the test-operation start time for pieces of air-conditioning equipment belonging to the first refrigerant circuit. Since, in many cases, test operations of pieces of air-conditioning equipment belonging to different refrigerant circuits are started at different times, convenience can be improved similarly.

In the case where the test-operation schedule is produced by the mobile-terminal control unit 501 or the administrative-server control unit 901, it is possible to automatically set the time which is a predetermined time after the current time, as the test-operation start time for the first group (the refrigerant circuit) of pieces of air-conditioning equipment, so that the user does not need to set the test-operation start time. Therefore, convenience can also be improved.

In the case where the test-operation schedule is produced by the mobile-terminal control unit 501 or the administrative-server control unit 901, the system may be configured such that pieces of air-conditioning equipment on which test operations are concurrently performed is selected as a group on the basis of the maximum power-supply capacity in the property information indicated in FIG. 13. That is, although the mobile-terminal control unit 501 or the administrative-server control unit 901 produces a schedule such that pieces of air-conditioning equipment belonging to an identical refrigerant circuit are regarded as a group and test operations of the pieces of air-conditioning equipment are concurrently started, the mobile-terminal control unit 501 or the administrative-server control unit 901 classifies the pieces of air-conditioning equipment belonging to an identical refrigerant circuit into groups, and produces a schedule such that the test operations classified into different groups are started at different times, in the case where a great number of pieces of air-conditioning equipment belong to the identical refrigerant circuit and the maximum power-supply capacity is exceeded when test operations of the pieces of air-conditioning equipment belonging to the identical refrigerant circuit are concurrently performed.

In addition, in the case where the above mobile-terminal control unit 501 or administrative-server control unit 901 produces a test-operation schedule, and the number of pieces of air-conditioning equipment belonging to each of refrigerant circuits is small, and a sufficient margin to the maximum power-supply capacity exists even when test operations of the pieces of air-conditioning equipment belonging to each of refrigerant circuits are concurrently performed, it is possible to schedule the test operations such that test operations of pieces of air-conditioning equipment belonging to different refrigerant circuits are performed in the time zone concerned, under the condition that the maximum power-supply capacity is not exceeded. The mobile-terminal control unit 501 or administrative-server control unit 901 derives the amount of power consumption in each piece of air-conditioning equipment on the basis of the capacity and equipment type of the piece of air-conditioning equipment by referring to the product databases stored in the storage unit 905. Thus, the test operations can be easily performed by use of the mobile terminal 5, and can be efficiently performed in consideration of the maximum power-supply capacity of the building.

Alternatively, in the case where the above mobile-terminal control unit 501 or administrative-server control unit 901 produces a test-operation schedule, it is possible to change the durations of the test operations on the basis of the capacity of the respective pieces of air-conditioning equipment, the piping length, the piping elevation difference, and the number of connected pieces of air-conditioning equipment per refrigerant circuit, instead of equalizing the durations of the test operations over the pieces of air-conditioning equipment. That is, it is considered that in the case where the air-conditioning capacity is high (the capacity is great), or the piping length is great, or the piping elevation difference is great, or the number of connected pieces of air-conditioning equipment per refrigerant circuit is great, the amount of refrigerant increases and a longer time is needed until the operation is stabilized, so that the mobile-terminal control unit 501 or administrative-server control unit 901 increases the durations of the test operations. In the opposite case, the mobile-terminal control unit 501 or administrative-server control unit 901 decreases the durations of the test operations.

In addition, the mobile-terminal control unit 501 or the administrative-server control unit 901 derives the capacity of each piece of air-conditioning equipment, the piping length, and the piping elevation difference by referring to the air-conditioning-equipment information stored in the storage unit 905 in the administrative server 9 as indicated in FIG. 13. Further, the number of connected pieces of air-conditioning equipment per refrigerant circuit can be calculated from the air-conditioning-equipment information indicated in FIG. 13. Thus, the test operations can be easily performed by use of the mobile terminal 5, and the duration of the test operation can be efficiently set for each piece of air-conditioning equipment.

Concrete examples in which a user produces a test-operation schedule by using the air-conditioner test-operation application executed by the mobile terminal 5 and manipulating the manipulation unit 505 are explained below. The user can make, by manipulating the manipulation unit 505, a setting for performing test operations at times differently shifted for the respective refrigerant circuits, or a setting for performing test operations at times differently shifted for the respective pieces of air-conditioning equipment. The mobile-terminal control unit 501 produces a test-operation schedule on receipt of a signal of this manipulation.

For example, in the case where the user makes a manipulation on the manipulation unit 505 for shifting the times of the test operations on the respective refrigerant circuit in steps of 30 minutes, the mobile-terminal control unit 501 sets a predetermined duration (e.g., two hours) from a predetermined time (e.g., 9:00) to an end time (e.g., 11:00) for a first refrigerant circuit, and a predetermined duration (e.g., two hours) from a predetermined time (e.g., 9:30) (which is shifted by 30 minutes from the above predetermined time for the first refrigerant circuit) to an end time (e.g., 11:30) for a second refrigerant circuit, and causes the display unit 504 to display the test-operation schedule information for each refrigerant circuit which is set as above.

Alternatively, in the case where the user makes a manipulation on the manipulation unit 505 for shifting the times of the test operations for every predetermined number of pieces of air-conditioning equipment in steps of 30 minutes, the mobile-terminal control unit 501 sets a predetermined duration (e.g., two hours) from a predetermined time (e.g., 9:00) to an end time (e.g., 11:00) for a first group of pieces of air-conditioning equipment, and a predetermined duration (e.g., two hours) from a predetermined time (e.g., 9:30) (which is shifted by 30 minutes from the above predetermined time for the first group of pieces of air-conditioning equipment) to an end time (e.g., 11:30) for a second group of pieces of air-conditioning equipment, and causes the display unit 504 to display the test-operation schedule information for each group of pieces of air-conditioning equipment which is set as above. Thus, the test operations can be easily performed by use of the mobile terminal 5, and can be flexibly set according to a demand of the user.

The screen B-1 in FIG. 12 is an example of a screen on the display unit 504 when a manipulation for displaying settings in the test-operation schedule produced by the mobile terminal 5 in step S903 in FIG. 9 is made. In the screen B-1, the test-operation mode, the test-operation start time, and the test-operation end time of pieces of air-conditioning equipment are displayed for each refrigerant circuit in the form of a list. The system is configured such that the indicated refrigerant circuit can be switched by tab selection.

When necessary, the setting is changed from the displayed information (S904). Examples of the screens displayed at this time are indicated in the screens B-1 to B-3 in FIG. 12. When a manipulation is made on the manipulation unit 505 for selecting on the screen B-1 a piece of equipment for which a setting change is required, the mobile-terminal control unit 501 receives a signal of this manipulation, changes the test-operation schedule, and controls the display unit 504 to cause a transition to the screen B-2. When a manipulation is made on the manipulation unit 505 for selecting on the screen B-2 an item for which a setting change is required, the mobile-terminal control unit 501 controls the display unit 504 to cause a transition to the screen B-3. Similarly, when a manipulation for selecting a preset value on the screen B-3 is made, a transition back to the screen B-2 occurs, and the changed setting information is stored in the storage unit 506 in the mobile terminal 5.

When the user makes on the manipulation unit 505 a manipulation for starting a test operation of the air-conditioning equipment (S905), the mobile-terminal control unit 501 transmits a signal of a request for starting the test operation to the wireless adapter 4 through the first wireless communication unit 502 (S906). The signal of the request for starting the test operation contains the test-operation schedule information which is produced in step S902 or changed in step S904. When the wireless-adapter control unit 401 receives the signal of the request for starting the test operation through the first wireless communication unit 403, the wireless-adapter control unit 401 transmits to the mobile terminal 5 a response signal regarding the starting of the test operation (S907), and stores the test-operation schedule information in the storage unit 404 (S908).

When any of the test-operation start times in the test-operation schedule information stored in step S908 is reached, the wireless-adapter control unit 401 transmits a control request signal through the air-conditioning-equipment communication unit 402 to a piece of air-conditioning equipment for which the reached test-operation start time is set (S909). The control request signal contains a request to operate in a test-operation mode included in the test-operation schedule information, and a request to operate with specific power which is set in the test-operation schedule. When the control unit (the outdoor-equipment control unit 106 or the indoor-equipment control unit 204) in the piece of air-conditioning equipment receives the control request signal through the communication unit (the outdoor-equipment communication unit 107 or the indoor-equipment communication unit 205), the control unit transmits a control response signal to the wireless adapter 4, and starts a test operation (S910). The wireless adapter 4, which receives the control response signal, updates the information on the current status stored in the storage unit 404, on the basis of the information contained in the control response signal (S911).

The control unit (the outdoor-equipment control unit 106 or the indoor-equipment control unit 204) in the piece of air-conditioning equipment the test operation of which is started transmits a notice of the current status to the wireless adapter 4 through the communication unit (the outdoor-equipment communication unit 107 or the indoor-equipment communication unit 205) (S912). This transmission is performed periodically, or when a predetermined condition of the piece of air-conditioning equipment changes. When the wireless-adapter control unit 401 receives the notice of the current status through the air-conditioning-equipment communication unit 402, the wireless-adapter control unit 401 confirms the information in the notice, determines whether or not the test operation is completed, and stores the result of the determination in the storage unit 404 (S913).

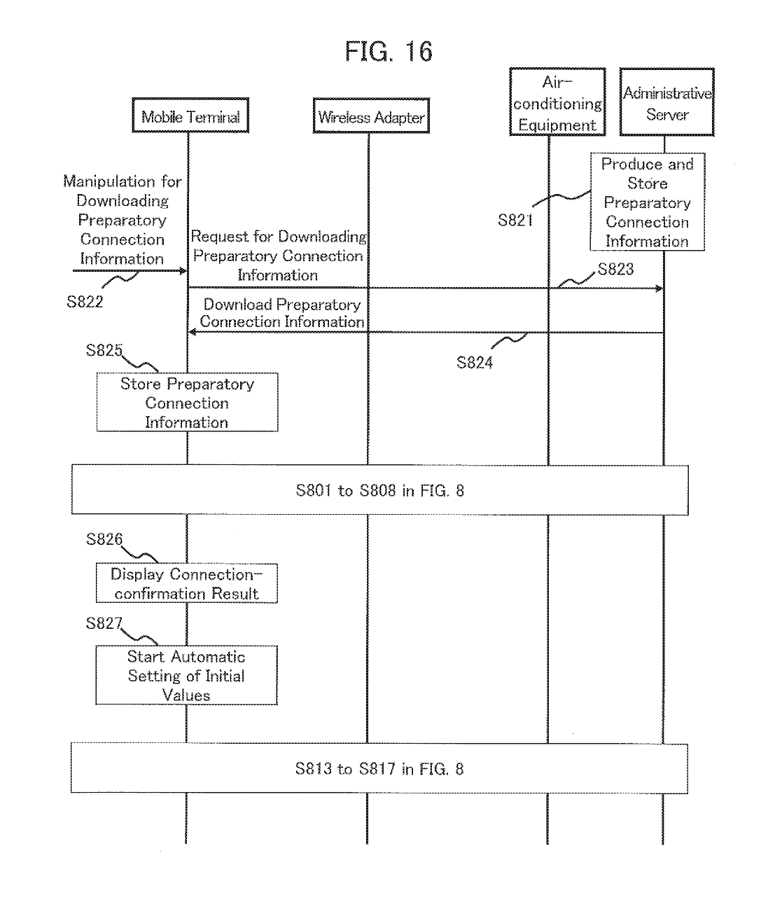

FIG. 15 illustrates an example of the data structure of test-operation result information. information indicating whether the test operation is normally completed, or is abnormally terminated, or is going on, or is being waited for is associated with each piece of air-conditioning equipment indicated by the refrigerant circuit and the address. In the case where the test operation is abnormally terminated, an alarm code indicating the reason for the abnormal termination is also associated with each piece of air-conditioning equipment. That is, according to the air-conditioner test-operation application executed by the mobile terminal 5 in the present embodiment, the mobile-terminal control unit 501 acquires refrigerant-circuit information and address information for the piece of air-conditioning equipment the test operation of which is performed, by accessing the administrative server 9, or by reading out the refrigerant-circuit information and the address information which are stored in the storage unit 506, and displays the acquired information on the display unit 504 in the mobile terminal 5. Although the indirect communication with the piece of air-conditioning equipment through the administrative server 9 is explained above, alternatively, the above information may be acquired by direct communication with the piece of air-conditioning equipment.

Then, the mobile-terminal control unit 501 displays on the display unit 504 information indicating whether or not the test operation of each piece of air-conditioning equipment is normally completed, on the basis of the information acquired by direct or indirect communication with the piece of air-conditioning equipment the test operation of which is performed.

The manner of judgment of the result of the test operation in step S913 is to determine abnormality when the measured value of a monitored physical quantity related to the refrigeration cycle of a piece of air-conditioning equipment subject to the test-operation judgment becomes a predetermined value, where the monitored physical quantity is measured by, for example, the outside-air temperature sensor 41, the compressor-discharge-gas-piping temperature sensor 42, the heat-exchanger-piping temperature sensor 43, the high pressure sensor 51, and the low pressure sensor 52 (which are arranged in the outdoor equipment 1), and the intake temperature sensor 44, the blowout temperature sensor 45, the refrigerant-gas-piping temperature sensor 46, and the refrigerant-liquid-piping temperature sensor 47 (which are arranged in the indoor equipment 2), and the remote-controller temperature sensor 48 (which is arranged in the remote controller 12). This judgment may be made by the control unit (the outdoor-equipment control unit 106 or the indoor-equipment control unit 204) in each piece of air-conditioning equipment reading out the above measured values. Alternatively, it is possible to transmit the above measured values to the administrative server 9, the wireless adapter 4, or the mobile terminal 5, and make a judgment by the administrative-server control unit 901, the wireless-adapter control unit 401, or the mobile-terminal control unit 501, which receives the measured values.

The other parameters for use in making the judgment of the result of the test operation may be a monitored physical quantity related to the refrigeration cycle of a piece of air-conditioning equipment subject to the test-operation judgment such as the operational frequency which the outdoor-equipment control unit 106 designates for the compressor 101, the sum of the operational frequencies of more than one piece of outdoor equipment, the primary voltage and the secondary voltage of the internal inverter which are measured or calculated inside the compressor 101, the operational condition of the outdoor blower 104, the aperture of the outdoor expansion valve 105, the operational condition of the indoor blower 202, the aperture of the indoor expansion valve 203, or the like. Further, the result of the test operation may be judged on the basis of any combination of the above monitored physical quantities.

Among the above monitored physical quantities, the operational frequencies, the outdoor temperature, the primary current of the inverter, the secondary current of the inverter, the sum of the operational frequencies in the case where more than one piece of outdoor equipment exists, the high pressure, the low pressure, the intake temperature, the blowout temperature, and the difference between the intake temperature and the blowout temperature are parameters which are particularly important for determining whether or not the operation of each piece of air-conditioning equipment is normal. Further, the preset temperature, the operational mode, the air flow setting, and the alarm code, which are stored in the outdoor-equipment communication unit 207, may also be used for the judgment.

Hereinbelow, concrete examples of the manner of the test-operation judgment by the control unit (the outdoor-equipment control unit 106 or the indoor-equipment control unit 204, the administrative-server control unit 901, the wireless-adapter control unit 901, or the mobile-terminal control unit 501) are explained. These concrete examples can be applied to the cases where whichever of the above parameters is used. It is possible to consider a manner of judgment in which an upper limit value of the measured value of a monitored physical quantity related to the refrigeration cycle of the air-conditioning equipment subject to the test-operation judgment is predetermined, and the control unit determines abnormality when the upper limit value is exceeded, or when excess over the upper limit value continues for a predetermined time. Further, it is also possible to consider a manner of judgment in which abnormality is determined when the excess over the upper limit value occurs a predetermined number of times. On the contrary, it is possible to consider a manner of judgment in which normality is determined when excess over the upper limit value does not occur for a predetermined time.

In another example, it is possible to consider a manner of judgment in which a lower limit value of the measured value of a monitored physical quantity related to the refrigeration cycle of the air-conditioning equipment subject to the test-operation judgment is predetermined, and abnormality is determines when falling below the lower limit value occurs, or when falling below the lower limit value continues for a predetermined time. Further, it is also possible to consider a manner of judgment in which abnormality is determined when falling below the lower limit value occurs a predetermined number of times. On the contrary, it is possible to consider a manner of judgment in which normality is determined when falling below the lower limit value does not occur for a predetermined time. Furthermore, the judgment may be made on the basis of a combination of the upper limit value and the lower limit value.

In a further example, it is possible to consider a manner of judgment in which a normal range of the measured value of a monitored physical quantity related to the refrigeration cycle of the air-conditioning equipment subject to the test-operation judgment is predetermined, and abnormality is determined when the parameter value does not reach the normal range in a predetermined time. On the contrary, it is possible to consider a manner of judgment in which normality is determined when the parameter value reaches the normal range in a predetermined time. In a yet further example, it is possible to consider a manner in which the aforementioned types of criterion values (the upper limit value, the lower limit value, and the like) are changed according to a preset temperature, the operational mode, and the air flow setting. Furthermore, abnormality is determined when the alarm code indicates any type of abnormality.

In the case where a judgment of normality or abnormality is confirmed at a time earlier than a scheduled time of completion of the test operation which is included in the test-operation schedule information, the test operation is terminated at that time. Although the manner of termination is different according to which control unit (the outdoor-equipment control unit 106 or the indoor-equipment control unit 204, the administrative-server control unit 901, the wireless-adapter control unit 401, or the mobile-terminal control unit 501) judges the test operation, finally, a command signal to stop a piece of air-conditioning-equipment is transmitted to the control unit (the outdoor-equipment control unit 106 or the indoor-equipment control unit 204) in the piece of air-conditioning equipment which is determined to be abnormal, or the control unit (the outdoor-equipment control unit 106 or the indoor-equipment control unit 204) in the piece of air-conditioning equipment determines its abnormality by itself. Then, the control unit (the outdoor-equipment control unit 106 or the indoor-equipment control unit 204) controls the piece of air-conditioning equipment to terminate the test operation of the piece of air-conditioning equipment. In the case where the judgment is made by using the values measured by multiple sensors, when abnormality is determined on the basis of at least one measured value, the abnormality can be regarded as being confirmed. When normality is determined on the basis of every measured value, the normality is confirmed. Thus, it is possible to reduce the total test-operation time.

For example, in the case where the test operation is judged by the wireless adapter 4, the aforementioned types of criterion values (the upper limit value, the lower limit value, and the like) are stored in the storage unit 404 in the wireless adapter 4 in advance, and the aforementioned parameter is transmitted to the wireless adapter 4 by the control unit (the outdoor-equipment control unit 106 or the indoor-equipment control unit 204) in the piece of air-conditioning equipment, and the wireless-adapter control unit 401 receives this parameter, and makes an abnormality judgment of the test operation by comparing the transmitted parameter with the above types of criterion values (the upper limit value, the lower limit value, and the like) stored in the storage unit 404.

Alternatively, it is possible to store in advance the above-mentioned types of criterion values (the upper limit value, the lower limit value, and the like) in the storage unit 108 in the piece of outdoor equipment 1 or the storage unit 207 in the piece of indoor equipment 2. In this case, the control unit (the outdoor-equipment control unit 106 or the indoor-equipment control unit 204) in the piece of air-conditioning equipment can transmit the criterion values to the wireless adapter 4 in the connection-confirmation process in step S803, and then the wireless-adapter control unit 401 can store the criterion values in the storage unit 404. Further alternatively, it is possible to store the above-mentioned types of criterion values (the upper limit value, the lower limit value, and the like) in the storage unit 506 in the mobile terminal 5 in advance. In this case, the mobile-terminal control unit 501 transmits the criterion values to the wireless adapter 4 by inserting the criterion values in the request for starting the test operation in step S906, and the wireless-adapter control unit 401 can receive the criterion values, and store the criterion values in the storage unit 404 in the wireless adapter 4. Yet further alternatively, it is possible to store the above criterion values in the storage unit 905 in the administrative server 9 in advance. In this case, the mobile terminal 5 can acquire the criterion values in the process of producing the test-operation schedule in step S902, and the mobile-terminal control unit 501 can transmit the criterion values to the wireless adapter 4 by inserting the criterion values in the request for starting the test operation in step S906, and the wireless-adapter control unit 401 can receive the criterion values, and store the criterion values in the storage unit 404 in the wireless adapter 4.

When the wireless adapter 4 recognizes that the test operation is completed at a time earlier than a scheduled time of completion of the test operation which is included in the test-operation schedule information, the wireless adapter 4 resets the test-operation schedule information (S914). That is, in the present embodiment, the control unit (the outdoor-equipment control unit 106 or the indoor-equipment control unit 204, the administrative-server control unit 901, the wireless-adapter control unit 401, or the mobile-terminal control unit 501) which is to make abnormality judgment of a test operation determines that the test operation is normally completed when the monitored physical quantity or quantities related to the refrigeration cycle of a piece of air-conditioning equipment subject to the judgment satisfy a predetermined condition. When the mobile-terminal control unit 501 receives a signal indicating normal completion of the test operation, the mobile-terminal control unit 501 displays on the display unit 504 the normal completion of the test operation of the piece of air-conditioning equipment.

In this case, when the mobile-terminal control unit 501 or the administrative-server control unit 901 which produces the test-operation schedule receives the signal indicating normal completion of the test operation from the control unit (the outdoor-equipment control unit 106 or the indoor-equipment control unit 204, the administrative-server control unit 901, the wireless-adapter control unit 401, or the mobile-terminal control unit 501) which is to make abnormality judgment of a test operation, the mobile-terminal control unit 501 or the administrative-server control unit 901 changes the test-operation schedule so as to advance the test-operation start time of one or more pieces of air-conditioning equipment belonging to a group of pieces of air-conditioning equipment or a refrigerant circuit the test operation of which is to be started next.

In addition, in the case where the control unit (the outdoor-equipment control unit 106 or the indoor-equipment control unit 204, the administrative-server control unit 901, the wireless-adapter control unit 401, or the mobile-terminal control unit 501) which is to make abnormality judgment of a test operation determines that an abnormality occurs in the test operation because a monitored physical quantity related to a refrigeration cycle of a piece of air-conditioning equipment subject to judgment falls into a predetermined condition, when a predetermined manipulation is made on the manipulation unit 505 in the mobile terminal 5 and the mobile-terminal control unit 501 receives a signal indicating the abnormality of the test operation, the mobile-terminal control unit 501 controls the display unit 504 to display the occurrence of the abnormality in the test operation of the piece of air-conditioning equipment.

In the air-conditioning system described above, after a test operation is started, either of the control units (the outdoor-equipment control unit 106 or the indoor-equipment control unit 204, the administrative-server control unit 901, the wireless-adapter control unit 401, or the mobile-terminal control unit 501) automatically makes abnormality judgment of the test operation, and the result of the abnormality judgment can be confirmed by use of the mobile terminal 5. Therefore, even a person of a service supplier not having a high skill can easily perform test operation. In addition, when a test operation is completed at a time earlier than the scheduled time, the schedule of the next test operation is advanced, so that test operations can be performed in a short time.

Thereafter, the processes in steps S909 to S914 are repeated for every piece of air-conditioning equipment subject to the test-operation schedule on the basis of the test-operation schedule information which is reset.

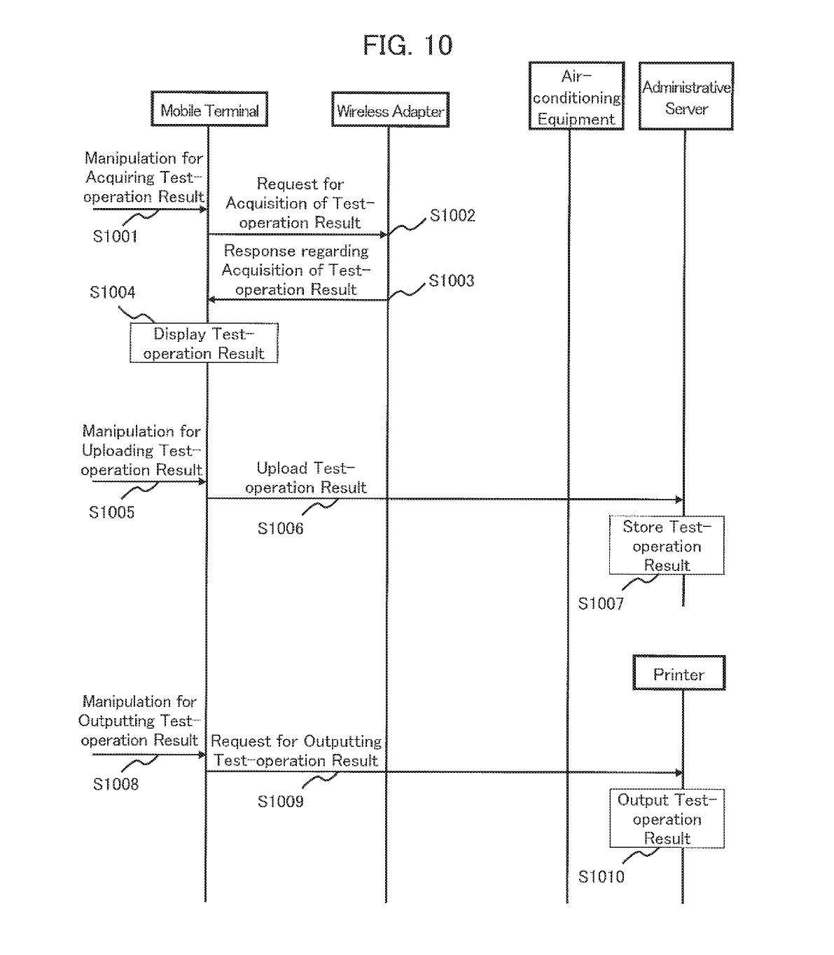

FIG. 10 is a process flow diagram related to a manipulation for confirming a test-operation result and a manipulation for uploading the test-operation result, among the manipulations for test operation by use of the mobile terminal 5. In addition, FIG. 12 illustrates examples of screens which are displayed on the mobile terminal at that time.

When the user of the mobile terminal 5 starts the air-conditioner test-operation application (which is stored in the storage unit 506) by manipulating the manipulation unit 505, and makes a manipulation for acquiring a test-operation result of a piece of air-conditioning equipment (S1001), the mobile-terminal control unit 501 in the mobile terminal 5 transmits a request signal for acquiring a test-operation result to the wireless adapter 4 through the first wireless communication unit 502 (S1002). The request signal for acquiring a test-operation result may require information on a single piece of air-conditioning equipment, or collectively require information on multiple pieces of air-conditioning equipment. When the wireless-adapter control unit 401 in the wireless adapter 4 receives the request signal for acquiring a test-operation result through the first wireless communication unit 403, the wireless-adapter control unit 401 transmits a response signal regarding acquisition of a test-operation result to the mobile terminal 5 (S1003). The response signal regarding acquisition of a test-operation result contains the test-operation result information stored in step S913.

The mobile-terminal control unit 501 in the mobile terminal 5 controls the display unit 504 to display the test-operation result information on the piece of air-conditioning equipment which is contained in received response regarding acquisition of a test-operation result (S1004). Examples of screens displayed at this time are illustrated in FIG. 12. When the user makes a manipulation for acquiring a result list on the screen B-1 on the mobile terminal 5 by using the manipulation unit 505, the mobile-terminal control unit 501 controls the display unit 504 to display a test-operation result of piece(s) of air-conditioning equipment for each refrigerant circuit in the form of a list. In this case, the mobile-terminal control unit 501 controls the display unit 504 to display the result of a test operation of each piece of air-conditioning equipment when the test operation is completed, and information indicating the status of each piece of air-conditioning equipment when the piece of air-conditioning equipment is in test operation or waiting for a test operation.

In the present examples, pieces of air-conditioning equipment connected to each refrigerant circuit are displayed along a vertical line in such a manner that the screen can be switched from one refrigerant circuit to another by tab selection. Alternatively, the system may be configured such that the screen is switched for each piece of air-conditioning equipment subject to test operation. Thus, the user can easily confirm the test-operation result of all the pieces of air-conditioning equipment by using the limited space of the display unit 504 in the mobile terminal 5.

In addition, when a manipulation for uploading a test-operation result of a piece of air-conditioning equipment is made on the manipulation unit 505 by using the air-conditioner test-operation application on the mobile terminal 5 (S1005), the mobile-terminal control unit 501, which receives a signal of this manipulation, transmits a signal indicating the test-operation result to the administrative server 9 through the second wireless communication unit 503 (S1006). The administrative server 9 receives the signal through the LAN communication unit 902, and stores the received test-operation result in the storage unit 905 (S1007).

Thus, the test-operation results of all the pieces of air-conditioning equipment can be easily stored in the administrative server by using the mobile terminal 5. Since the test-operation results are stored in the administrative server 9, the test-operation results can be used by the other equipment, and convenience is improved.

In addition, it is possible to consider a manner in which values measured by the respective sensors and used in the judgment of the test-operation result in step S913 are contained in the response regarding acquisition of a test-operation result in step S1003. In this case, the values measured by the respective sensors and used in the judgment of the test-operation result in step S913 are indicated in the display of the test-operation result in step S1003. Further, the values measured by the respective sensors and used in the judgment of the test-operation result in step S913 are included in the uploaded test-operation result in step S1006, and are stored in step S1007. Thus, detailed test-operation data of all the pieces of air-conditioning equipment can be easily stored in the administrative server by using the mobile terminal 5. Since the detailed test-operation data are stored in the administrative server, the test-operation results can be used by the other equipment, and convenience is improved.

When a manipulation for outputting the test operation result is made by using the air-conditioner test-operation application stored in the storage unit 506 in the mobile terminal 5 (S1008), the mobile terminal 5 transmits to the printer 11 a request for outputting the test-operation result (S1009). The request for outputting the test-operation result contains screen data which is to be outputted. The printer 11 outputs (prints out) the test-operation result (S1010). Thus, the test-operation result can be easily outputted from the printer by using the mobile terminal 5.

### Embodiment 2

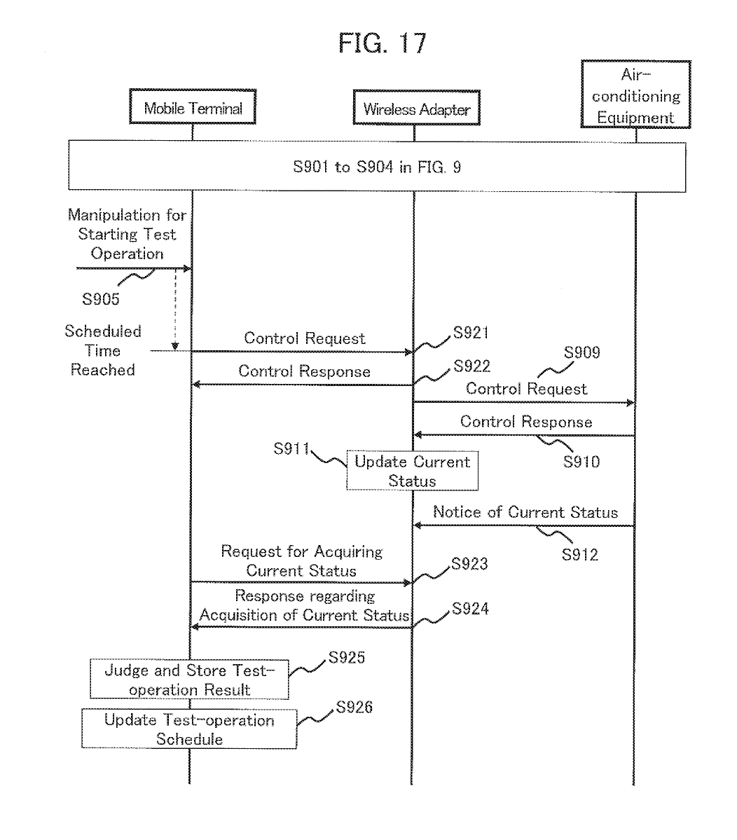

In the present embodiment, a method for automatically informing a user of a connection-confirmation result and a method for automatically setting initial values on the basis of data which is produced in advance are explained below. In the following explanations, the matters identical to the embodiment 1 are omitted. The overall system configuration and the function block diagram of the respective pieces of equipment are identical to those in the embodiment 1, and only the process flow in FIG. 8 is different from embodiment 1. The process flow in the present embodiment is indicated in FIG. 16.

At first, preparatory connection information is stored in the storage unit 905 in the administrative server 9 in advance (S821). The preparatory connection information has a data structure similar to the air-conditioning-equipment information in the connection-confirmation information indicated in FIG. 13. For example, the preparatory connection information contains the sequence number, the refrigerant circuit, the address, the equipment type, various conditions, various preset values, the piping length, and the piping elevation difference (the elevation difference between the inlet and the outlet of the piping), which are assigned to each piece of air-conditioning equipment. Production of the preparatory connection information may be performed by using the manipulation unit 904 in the administrative server 9 such that a signal of the manipulation is received by the administrative-server control unit 901 and stored in the storage unit 905, or by manipulating the mobile terminal 5 or the information terminal 10 through a network such that a signal of the manipulation is transmitted from the control unit in the mobile terminal 5 or the information terminal 10 to the administrative server 9.

When a manipulation for downloading the preparatory connection information for the air-conditioning equipment is made on the manipulation unit 505 by using the air-conditioner test-operation application stored in the storage unit 506 in the mobile terminal 5 (S822), the mobile-terminal control unit 501, which receives a signal of this manipulation, transmits to the administrative server 9 a request signal for downloading the preparatory connection information (S823). The administrative-server control unit 901, which receives the request signal through the LAN communication unit 902, transmits a signal of preparatory connection information to the mobile terminal 5 (S824). The mobile-terminal control unit 501, which receives this signal, stores the preparatory connection information in the storage unit 506 (S825).

Thereafter, the processes in steps S801 to S808 are performed. When connection confirmation is completed, the mobile-terminal control unit 501 in the mobile terminal 5 compares the current status of the pieces of air-conditioning equipment with the preparatory connection information stored in the mobile-terminal control unit 501 in the mobile terminal 5, and controls the display unit 504 to display the result of the connection confirmation (S826). For example, in the case where, although an equipment type is associated with a refrigerant circuit and an address in the preparatory connection information, no piece of air-conditioning equipment is connected to the refrigerant circuit and the address or a piece of air-conditioning equipment of a different equipment type from the equipment type indicated in the preparatory connection information is connected to the refrigerant circuit and the address according to the confirmed status of the pieces of air-conditioning equipment, the mobile-terminal control unit 501 controls the display unit 504 to indicate that the result of the connection confirmation is abnormal. At this time, the mobile-terminal control unit 501 controls the display unit 504 to display the occurrence of the abnormality, the refrigerant circuit and the address at which the abnormality occurs, the equipment type of the piece of air-conditioning equipment which should be originally connected (the information contained in the preparatory connection information), and the equipment type of the piece of air-conditioning equipment which is actually connected.

When an abnormality is detected, the cause of the abnormality is removed, and connection confirmation is performed again.

When the connection confirmation is normally completed in all respects, a process for automatically setting various preset values in the preparatory connection information is started (S827). Details of the process for actually setting initial values are similar to steps S813 to S817 in FIG. 8.

As explained above, it is possible to easily confirm the connection-confirmation result by using the mobile terminal 5, and easily perform initial-value of each piece of air-conditioning equipment.

### Embodiment 3

In the present embodiment, a concrete method for performing schedule control of test operation from the mobile terminal 5, instead of the wireless adapter 4, in the air-conditioner test-operation system is explained. In the following explanations, the matters identical to the embodiment 1 are omitted. The overall system configuration and the function block diagram of the respective pieces of equipment are identical to the embodiment 1, and only the process flow in FIG. 9 is different from the embodiment 1. The process flow in the present embodiment is indicated in FIG. 17.

After the processes in steps S901 to S904 are performed as in FIG. 9, the user makes on the manipulation unit 505 a manipulation for starting a test operation of air-conditioning equipment (S905). Thereafter, when a test-operation start time which is set in a test-operation schedule is reached, the mobile-terminal control unit 501 transmits a control request signal to the wireless adapter 4 through the first wireless communication unit 502 (S921). The control request signal contains a request to operate in a test-operation mode included in the test-operation schedule information, and a request to operate with specific power for the test operation. When the control unit 401 receives a test-operation start request signal through the first wireless communication unit 403, the wireless-adapter control unit 401 transmits a control response signal to the mobile terminal 5 (S922). In addition, the wireless adapter 4 performs the processes in steps S909 to S912 between the wireless adapter 4 and the piece(s) of air-conditioning equipment.

Thereafter, in order to confirm whether or not the test operation of the piece(s) of air-conditioning equipment is completed, the mobile-terminal control unit 501 in the mobile terminal 5 periodically transmits a request for acquiring the current status, through the first wireless communication unit 502 to the wireless adapter 4 (S923). The wireless-adapter control unit 401 in the wireless adapter 4, which receives through the first wireless communication unit 403 the request for acquiring the current status, transmits a response signal regarding acquisition of the current status, to the mobile terminal 5 (S924). In addition, the processes in steps S923 and S924 are similar to the processes in steps S806 and S807 in FIG. 8.

When the mobile-terminal control unit 501 receives through the first wireless communication unit 502 the response signal regarding acquisition of the current status, the mobile-terminal control unit 501 confirms the contents of the response signal, judges whether or not the test operation is completed, and stores the result of the judgment in the storage unit 506 (S925). The process in step S925 is similar to the process in step S913 in FIG. 9. The manner of judgment is similar to the embodiment 1. The respective criterion values (the upper limit value, the lower limit value, and the like) are stored in advance in the storage unit 506 in the mobile terminal 5, and the aforementioned parameter is transmitted from the control unit (the outdoor-equipment control unit 106 or the indoor-equipment control unit 204) in the piece of air-conditioning equipment through the wireless adapter 4 to the mobile terminal 5. The mobile-terminal control unit 501, which receives the parameter, makes an abnormality judgment of the test operation by comparing the parameter with the respective criterion values (the upper limit value, the lower limit value, and the like).

When the mobile-terminal control unit 501 recognizes that the test operation is completed at a time earlier than the scheduled time of completion of the test operation contained in the test-operation schedule information, the mobile-terminal control unit 501 resets the test-operation schedule information (S926). Since the process in step S926 is similar to the process in step S914 in FIG. 9, the process in step S926 is not explained in detail.

As explained above, when a test operation is completed earlier than the schedule, the schedule of the next test operation is advanced. Therefore, the test operation can be performed in a short time. In addition, although the mobile terminal 5 is assumed to make the judgment of the test operation in this example, alternatively, it is possible to transfer all or part of information on the current status of the air-conditioning equipment from the mobile terminal 5 to the administrative server 9, judge the result of the test operation by the administrative server 9, and transfer the result of the test operation from the administrative server 9 to the mobile terminal 5.

Further alternatively, it is possible to perform by the administrative server 9 the process for updating the test-operation schedule, and transfer the test-operation schedule information from the administrative server 9 to the mobile terminal 5.

Therefore, even in the case where the mobile terminal 5 is an inexpensive type having low processing capacity, judgment of the test-operation result and reconstruction of the test-operation schedule can be performed in a short time.

### LIST OF REFERENCE SIGNS

1: Outdoor Equipment; 2: Indoor Equipment; 3: Centralized Control Equipment; 4: Wireless Adapter; 5: Mobile Terminal; 6: Air-conditioner-communication Transmission Line; 7: Wide-area Wireless Base Station; 8: Internet; 9: Administrative Server; 10: Information Terminal; 11: Printer; 12: Remote Controller; 101: Compressor; 102: Four-way Valve; 103: Outdoor Heat Exchanger; 104: Outdoor Blower; 105: Outdoor Expansion Valve; 201: Indoor Heat Exchanger; 202: Indoor Blower; 203: Indoor Expansion Valve; 31: Gas Piping; 32: Liquid Piping; 41: Outdoor-air Temperature Sensor; 42: Compressor-discharge-gas-piping Temperature Sensor; 43: Heat-exchanger-piping Temperature Sensor; 44: Intake Temperature Sensor; 45: Blowout Temperature Sensor; 46: Refrigerant-gas-piping Temperature Sensor; 47: Refrigerant-liquid-piping Temperature Sensor; 48: Remote-controller Temperature Sensor; 51: High-pressure Sensor, 52: Low-pressure Sensor

1. An air-conditioner test-operation application executed by a mobile terminal, wherein
when a predetermined manipulation is made on a manipulation unit in the mobile terminal, a control unit in the mobile terminal causes a display unit in the mobile terminal to display information on equipment types of ones, belonging to a group other than a predetermined group subject to a test operation, of pieces of outdoor equipment and pieces of indoor equipment constituting an air-conditioning system, and not to display information on equipment types of ones, belonging to the predetermined group, of the pieces of outdoor equipment and the pieces of indoor equipment, and
when a manipulation for display switching is made on the manipulation unit in the mobile terminal, the control unit in the mobile terminal causes the display unit in the mobile terminal to display the information on the equipment types of the ones belonging to the predetermined group which is not displayed until then, and not to display the information on the equipment types of the ones belonging to the group other than the predetermined group which is displayed until then.

2. The air-conditioner test-operation application according to claim 1, wherein when a manipulation for acquiring current status is made on the manipulation unit, the control unit in the mobile terminal receives current-status information on pieces of air-conditioning equipment connected to the air-conditioning system, and when a predetermined manipulation is made on the manipulation unit in the mobile terminal, the control unit in the mobile terminal causes the display unit to display the received current-status information.

3. The air-conditioner test-operation application according to claim 1, wherein when a manipulation for uploading connection information on the air-conditioning system is made on the manipulation unit in the mobile terminal, the control unit in the mobile terminal transmits a signal of the connection information on the air-conditioning system to an administrative server which is connected with the mobile terminal through the Internet, and an administrative-server control unit in the administrative server, which receives the signal of the connection information, stores the received connection information in a storage unit.

4. An air-conditioner test-operation application executed by a mobile terminal, wherein
when a predetermined manipulation is made on a manipulation unit in the mobile terminal, a control unit in the mobile terminal acquires refrigerant-circuit information and address information on a piece of air-conditioning equipment which can be subject to test operation, by accessing an administrative server or reading out the refrigerant-circuit information and the address information which are stored in a storage unit, and controls a display unit in the mobile terminal to display the refrigerant-circuit information and the address information, and
when a manipulation for setting a start time of a test operation for each piece of air-conditioning equipment is made on the manipulation unit in the mobile terminal, the control unit in the mobile terminal controls the display unit to display the start time of the test operation for each piece of air-conditioning equipment which is set by the manipulation for setting a start time of a test operation.

5. The air-conditioner test-operation application according to claim 4, wherein when a manipulation for setting an end time of a test operation for each piece of air-conditioning equipment is made on the manipulation unit in the mobile terminal, the control unit in the mobile terminal controls the display unit to display the end time of the test operation for each piece of air-conditioning equipment which is set by the manipulation for setting an end time of a test operation.

6. The air-conditioner test-operation application according to claim 4, wherein when a manipulation for setting a test-operation mode of a test operation of each piece of air-conditioning equipment is made on the manipulation unit in the mobile terminal, the control unit in the mobile terminal controls the display unit to display the test-operation mode for each piece of air-conditioning equipment which is set by the manipulation for setting a test-operation.

7. An air-conditioner test-operation application executed by a mobile terminal, wherein
when a predetermined manipulation is made on a manipulation unit in the mobile terminal in a situation in which a control unit which is to make abnormality judgment of a piece of air-conditioning equipment subject to a test operation determines that a monitored physical quantity related to a refrigeration cycle of the piece of air-conditioning equipment subject to judgment satisfies a predetermined condition and the test operation is normally completed, a control unit in the mobile terminal controls a display unit in the mobile terminal to indicate normal completion of the test operation of the piece of air-conditioning equipment, on receipt of a signal of normal completion of the test operation.

8. The air-conditioner test-operation application according to claim 7, wherein when a predetermined manipulation is made on the manipulation unit in the mobile terminal in a situation in which the control unit which is to make abnormality judgment of a piece of air-conditioning equipment subject to a test operation determines that a monitored physical quantity related to a refrigeration cycle for the piece of air-conditioning equipment subject to judgment falls into a predetermined condition and an abnormality occurs in the test operation, the control unit in the mobile terminal controls the display unit in the mobile terminal to indicate occurrence of the abnormality in the test operation of the piece of air-conditioning equipment, on receipt of a signal of the abnormality in the test operation.

9. The air-conditioner test-operation application according to claim 7, wherein when the control unit in the mobile terminal receives the signal of normal completion of the test operation, the control unit in the mobile terminal or an administrative-server control unit changes a test-operation schedule so as to advance a start time of a test operation of a piece of air-conditioning equipment belonging to a group of pieces of air-conditioning equipment or a refrigerant circuit the test operation of which is to be started next

10. An air-conditioner test-operation system, comprising:
air-conditioning equipment in which a piece of outdoor equipment including an outdoor heat exchanger and a piece of indoor equipment including an indoor heat exchanger are connected by refrigerant piping and a refrigerant circuit is constituted by circulating a refrigerant with a compressor, and which includes a detection means detecting either of an operational frequency, high pressure, low pressure, inverter primary current, inverter secondary current, and outdoor temperature of the compressor; and
a mobile terminal on which manipulation for test operation of the air-conditioning equipment is made;
characterized in that
the air-conditioner test-operation application as set forth in claim 1, is executed by the mobile terminal.
